(19) United States
(12) Patent Application Publication
(10) Pub. No.: US 2004/0133286 A1
(43) Pub. Date: Jul. 8, 2004

(54) Automatic control system

(76) Inventors: Takehiko Futatsugi, Annaka-shi (JP); Hiroo Sato, Takasaki-shi (JP)

Correspondence Address: GREER, BURNS & CRAIN, 300 S WACKER DR, 25TH FLOOR, CHICAGO, IL, 60606, US

(21) Appl. No.: 10/469,390

(22) PCT Filed: Jan. 10, 2001
(86) PCT No.: PCT/JP01/00060

(51) Int. Cl. G05B 13/02

(52) U.S. Cl. 700/28; 700/37

(57) ABSTRACT

The manipulated variable is calculated as a linear form of the command of fixed periods after and such data from fixed periods before, that are controlled variable until the present period, manipulated variable until the last period, and measurable disturbance until fixed periods after. The number/order of needed values is determined by order systemisation and is limited in small number. And coefficients are calculated solving propagator equation called COFRE under FT-determining. Using the deviation of estimation gap, changing of the system and the occurrence of not measurable disturbance are judged. When changing of the system is judged control parameters are tuned fast, and when the occurrence of not measurable disturbance are judged automatic tuning is stopped in order to avoid from that parameters are broken. The control period is also automatically optimised. The invented method is applicable for from the simple system to the complex system.

### TECHNICAL FIELD

The invention is an improvement of the control method called NACS (New Automatic Control System). In other words, the control system is made intelligent by the invention. The manipulated variable (represented by C), the controlled variable (R), the measurable disturbance (D), the command (S), and their differences are generally called COV (control variable). Feed forward of ‘D’ is naturally carried out in the system. ‘C’ is calculated solving the transfer equation called COFRE (control function representation) under the condition of FT-determining (finite time determining) namely both of ‘R’ and ‘C’ become constant in a fixed finite time. The formula of the solution, which is called MAFRE (Manipulation function representation), is a linear form of COV. COFRE has a theoretical base on the differential equation. The parameters of COFRE are called COF. The number or degree of COF is determined by degree systemisation. COF is identified by regression of COFRE. The identification of COF is carried out in normal phase by tuning diagnosis only when it is judged that COF is identified above the fixed precision and not-measurable disturbance, which are greater than noise level, doesn't happen. Thus the system is stable, even if strong not-measurable disturbance occurs when the control system is automatically tuned. When the system is restarted COF is checked by fast tuning so that the system can adapt for changing during the interruption such as repair or exchange of components. The control period is determined by optimisation of period so that COF can be identified above the fixed precision. And it is adaptable for various complex systems. For example: The motor control system that heavy load is charged and discharged. The combined system of speed control and position control. Temperature control in a pipe alternating the control point among the region from the upper stream to the down stream.

### BACKGROUND ARTS

Subscript symbols, which are not order of sequence, are underlined when these are not clear. And subscript symbols concerning characteristic values (eigenvalue) are underlined in wave. The symbol ‘Σᵢ’ means series sum concerning ‘i’ and the symbol ‘Πᵢ’ means series product concerning ‘i’. Underline distinguishes ‘Σ’ from ‘Σ’ that is the sum operator and an element of LRSF. Subscript ‘i’ is a dummy index and various and arbitrary symbols can be used instead of ‘i’. We use English letters from ‘i’ to ‘n’ or from ‘I’ to ‘N’ for dummy index or number. ‘i∈X’ means that ‘i’ is an element of the set ‘X’. Each of ‘[N]’, ‘N’, and ‘[M, N]’ means the set of integers of ‘1˜N’, ‘0˜N−1’ and ‘M˜N’. For the convenience's sake of description, the set of the dummy index may be defined apart from ‘Σ’ or ‘Π’. When the set is not defined, it is the set of whole integers.

Several formulas are used that are described in the mathematics formula dictionaries, for example.

Shigekazu Moriguchi, Keikyu Udagawa and Makoto Hitotsumatsu; Sugaku koshiki I, II, III (Mathematics formulas) Iwanami Shoten.

Left-regular-sequence-field (LRSF) is very convenient to represent causality in discrete algebra. But LRSF is not popular in control theorem. Therefore LRSF is described at first. LRSF is referred in the following reference.

Shiro Hayahara and Sigeru Haruki ‘Atarashi i ensanshiho to risankaisekikansuron’ (New operator method and discrete analytic function theory) Maki shoten.

LRSF is also referred little in the following reference, but it is very difficult for not-mathematician.

Nihon Sugakukai, ‘Iwanami Sugaku Jiten’ (Iwanami mathematics dictionary) Iwanami Shoten

Elements of a sequence of number are called terms and their position numbers are called orders. Terms are arranged from left to right so that the left term has the lower order than the right. The popular sequences in control theory begin from the first term and continue to the +∞th term. The set of these sequences is called RIS (right infinite sequence). We give it symbol ‘(1,)’. The set of sequences, which begins from the −∞th term and continue to the +∞th term, is called BIS (both side infinite sequence). We give it symbol ‘(,)’. We consider BIS and regard not-defined terms as 0. Thus RIS is the subset of BIS, whose terms of order that is lower than 1 are all 0. The subset, each element of which is an element of RIS shifted to left by finite order, is called LRSF (left regular sequence field). We give it symbol ‘[,)0’. The sequence, all terms of which are 0, is called zero sequence given symbol ‘0’. The rest LRSF except zero sequence is called LRS (left regular sequence) and is given symbol ‘[,)’.

The sequences, which can be not-LRSF, begin with Greece small characters, special LRSF begin with Greece capital letters or number letters, and normal LRSF begin with English letters.

α, β, γ, . . . ω∈(,)

A, B, C, . . . , Z, a, b, c, . . . ,z ∈[,)0⊂(,) (S01)

In principle, sequences, which begin with English small characters, are differences of the sequences that begin with the corresponding English capital letters. And the sequences, which begin with Greece small characters, are sums of sequences that begin with the corresponding English capital letters.

a=ΔA, b=ΔB, c=ΔC, . . .

α=ΣA, β=ΣB, γ=ΣC, (S02)

Each of LRS has a term that is not zero and its order is the lowest. It is called the start term, and its order is called the start order. The start order is represented by ‘@’ followed by an expression of sequences or by the symbol of a sequence. A sequence is represented by the nth term called general term in { }. When a term of expression or sequence is written in { }, it is its nth term.

α={βₙ₋₂}={Aₙ₋₅bₙ₊₂+n⁵}⇄αₙ=βₙ₋₂=Aₙ₋₅bₙ₊₂+n⁵ (S03)

The sequence, which has a finite numbers of not-zero terms, is called finite sequence. We give the set of finite sequences symbol ‘[,]’. Finite sequence has a term that is not zero and its order is the highest. It is called the end term, and its order is called the end order. The end order is represented by ‘&’ followed by an expression of sequences or by the symbol of a sequence. A LRS is represented as the following, too.

A={Aₙ}_{@=k, &=h}={Aₙ}_{[k, h]}, A={Aₙ}_{@=k} (S04)

The limit value ‘limit (n→+∞) Aₙ’ is represented by A_{∞}.

A finite sequence that is also RIS is called RFS (right finite sequence). The set of RFS is given symbol ‘(1,]’. The end order of RFS is called degree, too.

Addition of BIS is defined by addition of each term.

α+β≡{αₙ+βₙ} (S05)

Multiplication is defined by Cauchy-product namely convolution. When it is not clear where symbols of sequences are separated, ‘·’ is used for the symbol of multiplication.

αβ≡{Σᵢαᵢβₙ₋ᵢ}={Σᵢαₙ₋ᵢβᵢ}=α·β, 0α=0 (S06)

Since these definitions are symmetry and terms of sequences are numbers, associative law, commutative law, and distributive law are satisfied like number.

(α+β)+γ=α+(β+γ), (αβ)γ=α(βγ)

α+β=β+α, αβ=βα

α(β+γ)=αβ+αγ, (a+β)γ=αγ+βγ (S07)

Scalar multiplication is defined that each term is multiplied by the scalar i.e. number.

N β≡{N βₙ} N: Scalar (S08)

The scalar multiple of β and ‘−1’ is represented by ‘−β’ and subtraction is defined by the addition of α and −β.

−β≡(−1)β (S09)

α−β≡α+(−1)β (S10)

α−α=0 (S11)

We consider the sum of LRS in the case ‘A≠−B’. Then all terms of the sum, whose orders are lower than ‘@A’ and ‘@B’, are ‘0’. And at least one term that is ‘Aₙ+Bₙ≠0’ exists. Therefore ‘A+B’ is belong to LRS. Including the case of zero sequence, the sum of LRSF belongs to LRSF.

A≠−B [symbol] @(A+B)≧MIN(@A,@B) (S12)

Similarly, the difference of LRSF belongs to LRSF.

A≠B [symbol] @(A−B)≧MIN(@A,@B) (S13)

The terms of the product among LRS become as the following. All terms, whose orders are lower than ‘@A+@B’, are the sum of the product where either ‘Aᵢ’ or ‘Bₙ₋ᵢ’ is 0. Thus these terms are all 0. We can neglect the product of 0. The (@A+@B) th term is the product of ‘A_{@A}’ and ‘B_{@B}’ and it is not 0. All terms of higher order than ‘@A+@B’ are sums, each of which begins from the product of ‘A_{@A}’ and ends with the product of ‘B_{@B}’.

AB={A_{@A}B_{n-@A}+A_{@A+1}B_{n-@A-1} + . . . +A_{n-@B}B_{@B}}_{@=@A+@B} (S14)

A≠0, B≠0 [symbol] @AB=@A+@B (S15)

Therefore the start order is ‘@A+@B’. Considering the start term, it is clear that no zero divisors exist in LRSF.

AB=0 [symbol] A=0 or B=0 (S16)

This law is called reduction law. But zero divisors exist outside LRSF. For example, the following product between LRSF and not-LRSF is zero sequence.

{pⁿ}·{1, −p}_{[0, 1]}=0 (S17)

‘{1, −p}_{[}0, 1]’ is LRS that all terms except the 0th term and the 1st term are 0. ‘{pⁿ}’ is not LRSF. It is called regular that division is possible. Division is defined by solving the product among LRS from the start term.

C=A/B≡{C_{n<@c}=0, C_{@c}=A_{@A}/B_{@B},C_{N>@c}=(A_{n+@B}−C_{@a}B_{n-@C}−C_{@a+1}B_{n-@C-1}− . . . −Cₙ₋₁B_{@B+1})/B_{@B}} (S18)

@(A/B)=@A−@B A≠0, B≠0 (S19)

Addition, subtraction, and multiplication can be freely operated in integer. But division is strongly limited. For example, ‘1’ can not be divided by ‘3’. The circumstances are the same in RIS. Division except zero division can be freely operated in rational number extended from integer. So can be done in LRSF extended from RIS. The set is called field of quotients, in which division except by zero can be operated and which is expanded from the set where division is impossible or strongly limited. But division cannot be freely operated again in BIS extended from LRSF. It is one of the merits of LRSF that the favourite term can be shifted to the 0th order. Therefore the left side is called ‘past’ also, and the right side is called ‘future’. And the 0th order is considered ‘present’ for COV and time base point for ‘COF’. The four rules in arithmetic of LRSF are the same as rational number. The rules of vectors or matrixes are different from rational number so that commutative and reduction laws are not satisfied. But man must pays attention to that limits-operation is not closed in LRSF similar to rational number. Therefore man must confirm whether the resulted sequence belongs to LRSF.

The sum, difference and product among finite sequences are also finite sequences. But the quotient of finite sequences is generally not finite sequence. The rule of the end order is similar to the rule of the start order as the following.

a≠−b, a,b∈[,] [symbol] &(a+b)≧MAX (&a, &b) (S20)

a≠b, a,b∈[,] [symbol] &(a−b)≧MAX(&a,&b) (S21)

a,b≠0, a,b∈[,] [symbol] &ab=&a+&b, (ab)_{&ab}=a_{&a}b_{ab} (S22)

a,b≠0, a,b, a/b∈[,] [symbol] &(a/b)=&a−&b, (a/b)_{&a/b}=a_{&a}/b_{&b} (S23)

It is indispensable for the calculation of control to finish in finite times of operation. Therefore it is important to know the characteristics of finite sequences. We must however prepare for it.

The following sequences are called scalar sequences and their notation ‘N’ are scalar and represented by number letters. For example, ‘1’ means the unit sequence {1}_{[0,0], and ‘}0’ means zero sequence ‘{0}’. The product of ‘N’ and an arbitrary sequence ‘≢’ is the same as scalar multiple. Since it is not problem even if sequence ‘N’ is mixed with scalar ‘N’, both ‘N’ are regarded as the same.

N≡{N}_{[0,0]}={N₀=N,N_{n≠0}=0} (S24)

1={1₀=1, 1_{n≠0}=0} (S25)

0={0} (S26)

1α=α1=α, A/1=A (S27)

A∈[,) [symbol] A/A=1 (S28)

α−α=0, α+0=α−0=α, 0α=0 (S29)

Positive power method of BIS is defined by the following.

α¹≡α, αⁿ⁺¹≡ααⁿ, n∈[1, +∞] (S30)

And zero and negative power method of LRS is defined.

A∈[,) [symbol] Aⁿ⁻¹≡Aⁿ/A, A⁰=1n∈[−∞, =∞] (S31)

Operators for z-transformation, difference and sum are all represented by special LRS.

Λ≡{Λ₁=1} (S32)

Λ^{m}={Λ^{m}ₘ=1} (S33)

Z≡Λ⁻¹={Z₋₁=1}, Z^{m}={Z^{m}₋ₘ=1} (S34)

Arbitrary sequence ‘α’ is represented by its term using single term operator ‘Λ’.

α=ΣₙαₙΛⁿ (S35)

The sequence, whose order is lower than ‘α’ by m, is represented by ‘Λ^{m} α’ or ‘Z^{-m}α’, and the sequence, whose order is higher than ‘α’ by m, is represented by ‘Λ^{-m} α’ or ‘Z^{m}α’. We call ‘Λ^{m}’ past operators and ‘Z^{m}’ future operators. The 0th terms of ‘Λ^{m}α’ and ‘Z^{m}α’ are ‘α₋ₘ’ and ‘αₘ’. Both ‘Λ^{m}’ and ‘Z^{m}’ are called shift operators, too. Special sequences have plural names corresponding to the functions.

Λ^{m}α={α_{n-m}, (Λ}^{m}α)₀=α₋ₘ

Z^{m}α={αₙ₊ₘ}, (Z^{m}α)₀=αₘ (S36)

The definition of division can be represented using ‘Λ’.

C=A/B [symbol] C={A−(B−B_{@B}Λ_{@B})C}/(B_{@B}Λ_{@B}) (S37)

If ‘B=1−D, D∈(1,)’, the division becomes the following.

D∈(1,) [symbol] C=A/(1−D) [symbol] C=A+DC [symbol] A=C−DC (S38)

The product of the difference operator ‘Δ’ and an arbitrary sequence ‘α’ is the difference of ‘α’.

Δ≡1−Λ={1, −1}_{[0,1]}, Δα={αₙ−αₙ₋₁} (S39)

Σ≡Δ⁻¹={1}_{@=0}={ . . . , 0,0, Σ₀=1,1,1, . . . }=Z/(Z−1) (S40)

A sequence is called a constant sequence, whose terms, orders of which are higher than the start order, are all equal to the start term. Since ‘Σ’ is the constant sequence, whose start order is 0, arbitrary constant sequence is represented by the product of its start term, shift operator, and Σ.

A={A_{n≧@A}=A_{@A}}=A_{@A}Λ^{@A}Σ (S41)

The product of the sum operator ‘Σ’ and an arbitrary sequence ‘α’ is the sum of ‘α’. And the partial sums are represented by (S44).

Σα={Σ_{i ∈[-∞, n]}αᵢ} (S42)

(Zⁱ−Z^{j})Σa={Σ_{k ∈[j+1, i]}aₙ₊ₖ}={Aₙ₊₁−Aₙ₊ⱼ}, A=Σa (S43)

The combination of causality and the limitedness of the propagation velocity result “Only past can effect present and neither present nor future can effect present.” We let the causes be ‘C’ and ‘D’ and we let the result be ‘R’. The most universal linear expression is described as the following using RIS f and g.

R=fC+gD f,g∈(1,)

Rₙ=f₁Cₙ₋₁+f₂Cₙ₋₂+f₂Cₙ₋₂+ . . . +g₁Dₙ₋₁+g₂Dₙ₋₂+g₂Dₙ₋₂+ (S44)

This expression is called REFRE (REF-representation) and ‘f’ and ‘g’ are called IREF (Impulse response function). The sums of IREF ‘F’ and ‘G’ are called SREF (Step response function). IREF and SREF are called REF generally.

F=Σf, G=Σg (S45)

Considering ‘R’ itself can be the cause for ‘R’, the following expression is obtained.

R=qR+aC+bD q,a,b∈(1,) (S47)

The coefficients ‘q’, ‘a’ and ‘b’ are called COF (control function). And this expression is called COFRE (COF-representation). REF and COF are called CAF (causality function). COFRE is also represented using parameter sequences ‘X’ and ‘Y’.

R=aX+bY, C=(1−q)X, D=(1−q)Y (S47)

COFRE is explained as the following. Let's consider a bell. While the interval that the tongue touches the bell is short, the bell sounds for a while. The effect is represented by ‘a’ or ‘b’ when the tongue touches the bell. Namely ‘a’ and ‘b’ are signal transferring rates. And the left sound is represented by ‘q’ after the tongue gets separated. Therefore ‘q’ is damping rate and/or rotating rate of vibration phase. Since these effects are simple, ‘a’, ‘b’ and ‘q’ can usually be represented by RFS.

R=qR+aC+bD q, a,b∈(1,] (S48)

The start order of CAF must be equal or greater than one. The start order of CAF is simply expressed ‘one’ considering “Zero is only the special case”. Thus causality is represented by REFRE or COFRE and CAF. While linear expressions of sequences that satisfy causality are REFRE or COFRE, these can be said the most universal expressions, by which liner systems are represented in digital system. While NACS can deal with COFRE universally, limited types of COFRE can be derived from the differential equation. The following condition combines REFRE and COFRE, and makes both the same. The condition is called conversion formula.

a=(1−q)f, b=(1−q)g (S49)

The set of REFRE, COFRE and conversion formula is called NACS-set. NACS-set being set the major premise, digital control theory can be developed axiomatically.

Since ‘Δ’ and ‘Σ’ are LRS, NACS-set can be deformed to various expression multiplied both sides by ‘Δ’ or ‘Σ’.

r=fc+gd=qr+ac+bd, R=Fc+Gd=Qr+Ac+Bd,

ρ=FC+GD=fγ+gδ, R=Fc+gD=qR+Ac+bD (S50)

Where r=ΔR, c=ΔC, d=ΔD; F=Σf, G=Σg, Q=Σq, A=Σza, B=Σb; ρ=ΣR, γ=ΣC, δ=ΣD

Conversion formula can be represented solving about f or g.

f=a/(1−q)=a+qf, g=b/(1−q)=b+qg (S51)

Any finite sequence ‘a’ makes the sum ‘A’, whose terms, orders of which are higher than or equal ‘&a’, are constant ‘A_{&a}’.

aΣ[,], A=Σa [symbol] A_{n≧&a}=A_{&a}=a_{@a}+a_{@a+1}+ . . . +a_{@a} (S52)

If the terms of ‘A’ is constant, whose orders are higher than or equal M, ‘A’ is the sum of a finite sequence, whose end order is M.

A_{n≧M}=A_{M} [symbol] ∃a∈[,], &a=M, A=Σa (S53)

If LRS ‘B’ is the product between finite sequence ‘a’ and LRS ‘C’, and ‘C_{n≧M}’ are constant, then ‘B_{n≧M+&a}’ are constant, and the ‘ΔB’ is a finite sequence.

B=aC, C_{n≧M}=C_{M}, a∈[,] [symbol] B_{n≧M+&a}=A_{&a}C_{M}, A=Σa

[symbol]

&b=M+&a, b=ΔB.B=aC=aΣc=Σ(ac), b=ac (S54)

We described before that reduction law is not satisfied in BIS. Its example is represented as the following using ‘Λ’, and becomes (S55) when both sides are multiplied by ‘Z’.

{pₙ}·{1, −p}_{[0, 1]}={Pₙ}·(1−pΛ)=0 (S17)

(Z−p) {pₙ}=0 (S55)

This is a characteristic equation of BIS. If {pₙ} is substituted by LRS {pₙ}_{@=0}, (S55) is deformed to (S56).

(Z−p) {pₙ}_{@=0}=Z (S56)

(1−pΛ) {pₙ}_{@=0}=1, {pₙ}_{@=0}=1/(1−pΛ) (S57)

This is the characteristic problem of LRSF. We use its result only. If arbitrary finite sequence ‘b’ is factored as (S58) then ‘bₘ’ is a characteristic value and ‘1−bₘΛ’ is called a factor.

b∈[,] [symbol] b=b_{@b}Λ_{@b}Π_{m∈[&b-@b](}1−bₘΛ) (S58)

Characteristic values are numbered in the order of the absolute value and the same values are arranged serially. The sequence has ‘Kₘ’ characteristic values that is the same as ‘bₘ’ and ‘bₘ’ is located in the (Hₘ)th position among the same values. ‘Hₘ’ is called order of ‘bₘ’ and ‘Kₘ’ is called duplication value of ‘bₘ’. The inverse sequence ‘b⁻¹’ is expanded in partial fraction as the following.

b⁻¹=Σ_{m∈[&b-@b]}bₘ(1−bₘΛ)^{-Hm}=Σ_{m∈[&b-@b]}bₘbₘ (S59)

bₘ≡(1−bₘΛ)^{-Hm}={Hₘ+n−1) !bₘⁿ/(Hₘ−1)!n!}_{@=0} (S60)

The characteristic values used mainly in positive power method are customarily called zeros and the values used mainly in negative power method are called poles. And ‘bₘ’ is called a characteristic function and ‘bₘ’ is called a partial fraction coefficient. Since ‘(Hₘ+n−1)!/n!’ is polynomials of n, linear combinations of ‘bₘ’ are also linear combinations of ‘b′ₘ’ define by (S62). ‘!’ is a symbol of factorial. Conventionally ‘b′ₘ’ is also called a characteristic function, but it doesn't satisfy (S57) nevertheless. The start orders of both characteristic functions ‘bₘ’ and ‘b′ₘ’ are 0th.

if Hₘ>1 (Hₘ+n−1)!/n!=(n+1) . . . (n+Hₘ−1for n≧0

if Hₘ=1 (Hₘ+n−1)!/n!=1

if Hₘ<1 (Hₘ+n−1)!/n!≡0 (S61)

b′ₘ≡{n^{Hm-1}bₘⁿ}_{@=0} m∈[&b−@b] (S62)

If all absolute values of poles ‘bₘ’ are less than one then ‘b⁻¹’ is a sequence asymptoting to zero.

b∈[,]∀|bₘ|<1 [symbol] b_{∞}=0 (S63)

The quotient ‘a/b’ of finite sequences ‘a’ and ‘b’ is generally not a finite sequence. It is the condition for the quotient to become a finite sequence that ‘a’ has all factors of ‘b’.

b≠0, a,b,a/b∈[,] [symbol] {bₘ}⊂{aₘ} [symbol] {b′ₘ}⊂{a′_{m}} (S64)

The above { } doesn't mean sequence but set. This is the same as the factorisation of integers.

m≠0, n,m,n/m∈ integer [symbol] m is a measure of n (S65)

If the product of LRS ‘A’ and a finite sequence ‘b’ is a finite sequence ‘c’, then ‘A’ is a finite sequence divided by some of factors of ‘b’.

A∈[,), b,c∈[,], c=Ab

[symbol]

∃d ∈[,],A=d/Π_{m∈D⊂[&b-@a]}(1−bₘΛ) (S66)

This is the same as the relation between integers and rational numbers.

L∈rational number, m,n∈ integer, n=Lm

[symbol]

∃i,j∈integer, j is a measure of m, L=i/j (S67)

Control is the technology to investigate the causality, where the cause is the manipulated variable (C) and the result is the controlled variable (R). And it is also the art to calculate ‘C’, which makes ‘R’ agree the set value or the command (S). The equation of the causality is called the representation system, and the arithmetic of ‘C’ is called the determination system. It is also called identification or tuning to determine the representation system. And the identification during the control operation is called an automatic tuning. The determination system using the representation system is called MRAS (Model Reference Adaptive System). Since the determination system is determined only if the representation system is identified, an automatic tuning identifies the representation system in MRAS. While digital processors can be easily used today, digital control methods become popular. Digital control methods can be classified into two arts namely A-art and D-art. A-art simply regards D-system (digital system) as an approximation to A-System (analogue system) and adopts mainly the AS-settling (asymptotic settling) for its determination system. AS-settling is to make ‘R’ asymptote or approach to ‘S’ in infinite time like PID control. D-art regards D-System as an independent and complete system as far as possible, and adopts FT-settling (finite time settling). FT-settling is to make ‘R’ agree with ‘S’ in a finite time. The simplest FT-settling is realised using MTC (Minimal-Time Control). An electric circuit is drawn in FIG. 4 that a register (1) and a capacitor or condenser (2) are connected with a voltage source (3). The voltage of the source is the manipulated variable (C), and the voltage of the capacitor is the controlled variable (R). All ‘R’, ‘C’ and the command (S) are 0 volt initially. When ‘S’ is changed from 0 volts to ‘S₁’ volt, ‘C’ is changed to the Maximum voltage (C^{MAX}) by the switcher (4) (curve 5 of FIG. 5 ). While ‘R’ is observed, just time when ‘R’ becomes ‘S₁’, ‘C’ is changed to ‘S₁’. Then ‘R’ is maintained ‘S₁’ hereafter (curve 7 of FIG. 5). This method realises a perfect settling in the minimal time. In a digital control, ‘R’ is measured periodically, and then ‘C’ is calculated out using ‘R’. The measurement can hardly coincide with the matching of ‘R’ with ‘S₁’, even if the calculation time is negligible. The following art makes FT-settling possible. ‘C’ is set ‘C^{CAL}’, which is calculated to make ‘R’ agree ‘S₁’ at the next sampling time, instead of ‘C^{MAX}’ (curve 6 of FIG. 5). But if ‘C^{CAL}’ exceeds ‘C^{MAX}’ then ‘C^{CAL}’ is limited to ‘C^{MAX}’ and the calculation is tried in the next period. Thus FT-settling can be realised also in digital control (curve 8 of FIG. 5). The representation system is the following. Here, ‘f(s)’ is propagator and ‘f(t)’ is impulse response function (IREF) (curve 9 of FIG. 6).

f(s)=K/(s+s₀) s:Laplace transform operator

f(t>0)=K·exp(−s₀t) f(t):IREF (O01)

The representation system of the famous setting method for PID control proposed by J. G. Ziegler and N. B. Nichols has a form that this exponential function is combined with a dead time. The form is called Ziegler-Nichols model (curve 10 of FIG. 6). This method has been proved to be applicable to various PID controls.

f(s)=K·exp(−T_{L}S)/(s+s₀) t≦T_{L}:dead time

f(t≦T_{L})=0 f(t>T_{L}) =K·exp(−s₀(t−T_{L})) 0<s₀≠0 (O02)

Sosuke Iwai, ‘Seigyo kogaku kisoron’ (The Elemental Control Technology) Inc. Shokodo pp123-124 ‘Seigyo kogaku handobukku’ (Handbook for control technology) Asakura Shoten p186

Improved FT-settling for digital control has been proposed. The technology is referred in the following as ‘MRAS’.

Yasuto Takahoshi, ‘Shisutemu to seigyo I , II’ (Systems and controls 1,2) Iwanami Shoten 1978 (mainly referred in II)

‘Sugaku semina’ (Mathematics seminar) vol.21, No.07, 1982; PP.38˜44 Nihon Hyoron Sha

It is said the energy theorem is satisfied that ‘R’ becomes constant in a time when ‘C’ is maintained constant. Therefore IREF asymptotes to zero finally in the system, where the energy theorem is satisfied. Its IREF has an arbitrary form before the diminution where it decreases in an exponential function. This IREF is an extension of Ziegler-Nichols model (curve 11 of FIG. 6) (FIG. 3).

rₙ=f₁cₙ₋₁+f₂cₙ₋₂+f₃cₙ₋₃+ (O03)

rₙ≡Rₙ−Rₙ₋₁, cₙ≡Cₙ−Cₙ₋₁ (O04)

‘rₙ’ is the difference of the controlled variable ‘Rₙ’ in the nth period and ‘cₙ’ is the difference of the manipulated variable ‘Cₙ’. Because ‘Cₙ’ is calculated and output after ‘Rₙ’ is measured, ‘cₙ’ is not appeared in the right side of (O03). The exponential diminution part of IREF ‘f_{n>&a}’ is represented by a damping factor ‘q₁’. Here ‘&a’ means the beginning of the decrement. We use NACS' style that is different from the original.

f_{n>&a}=q₁fₙ₋₁ (O05)

rₙ−q₁rₙ₋₁=f₁cₙ₋₁+(f₂−q₁f₁)cₙ₋₂+(f₃−q₁f₂)cₙ₋₃+ . . . +(f_{&a}−q₁f_{&a-1})c_{n-&a}+(f_{&a+1}−q₁f_{&a})c_{n-&a-1}+ . . . =a₁cₙ₋₁+a₂cₙ₋₂+a₃cₙ₋₃+ . . . +a_{&a}c_{n-&a} (O06)

a₁≡f₁, a_{n>1}≡fₙ−q₁fₙ₋₁, a_{n>&a}=0 (O07)

rₙ=q₁rₙ₋₁+a₁cₙ₋₁+a₂cₙ₋₂+a₃cₙ₋₃+ . . . +a_{&a}c_{n-&a} (O08)

(O08) is called M-eq. The representation using M-eq is called ‘single pole representation’. COF is easily identified using regression methods such as least squares estimation or successive identification, which are well known. We suppose the present time is the Nth period and the command ‘S’ is constant from the next period (c_{n>N+1}=0). Then, if ‘R’ is settled in the (N+&a)th period and the (N+&a+1)th period, ‘R’ is settled forever thereafter as is concluded inductively.

$$\begin{matrix}{r}_{n > \& a + 1} = {q}_{1} {r}_{n - 1} + {a}_{1} {c}_{n - 1} + {a}_{2} {c}_{n - 2} + {a}_{3} {c}_{n - 3} + … + {a}_{\& a} {c}_{n - \& a} \\ = {q}_{1} {r}_{n - 1} = {q}_{1} ( {q}_{1} {r}_{n - 2} + {a}_{1} {c}_{n - 2} + … + {a}_{\& a} {c}_{n - \& a - 1} ) = … \\ = {q}_{1 n - \& a - 1} {r}_{\& a + 1} = 0\end{matrix}$$

This means that ‘R’ is settled in ‘&a’ periods if ‘C_{N}’ and ‘C_{N>N}=C_{N+1}’ are set so that ‘R’ is settled in the (N+&a)th and the (N+&a+1)th period. Namely, there is only a problem how ‘C_{N}’ and ‘C_{N+1}’ are calculated. A calculation method was proposed using a state vector (vₙ), which are renewed after the output of command ‘C_{N}’ in each period.

v_{n≠&a}=aₙc_{N}+Vₙ₊₁, V_{&a}=a_{N}c_{N}+q₁v_{&a} (O10)

This method is described in “Shisutemu to seigyo II”. Various identification methods are also explained in it. An application of this method for the crystal growth is referred in “Sugaku semina”. This method is not so hard to calculate ‘C’, but it is very difficult to understand and to explain. Without automatic tuning, the system is so perfectly settled in ‘&a’ periods as is the theory. Indeed “Shisutemu to seigyo II” warns to avoid automatic tuning, M-eq tempts to try it. The system suddenly becomes unstable. Not only in automatic tuning, the system becomes unstable even using COF, which are calculated from the data of the last control operation, which is successfully carried out. It is also other problem that there is no standard how much ‘&a’ is. ‘&a’ becomes more than twenty in some cases. Therefore, this method was gradually neglected. One of the applicants of this application, Mr. FUTATSUGI Takehiko tried to avoid these problems. He has used LRSF and succeeded in giving FT-settling a background theory or new control system, and also succeeded in finding the cause of unstability and the method to avoid the unstability. He had proposed Adtex inc. to bring this technology into practice. We applied following patents before this application.

JPA/H10-87887, PCT/JP99/00837, PCT/JP98/02017, PCT/JP99/02369, PCT/JP98/00959, PCT/JP98/02968, PCT/JP99/03519, PCT/JP98/01224

We call this new art NACS (New Automatic Control System) and the previous art OACS (Old Automatic Control System). It is clear that a vector using COF makes control unstable when COF is identified or renewed because old values and new values are mixed. He had to find other calculation method, too. But the problem was not only. NACS is described briefly. The previous representation system of NACS is NACS-set.

rₙ=q₁rₙ₋₁+ . . . +q_{&a}r_{n-&q}+a₁cₙ₋₁+ . . . +a_{&a}c_{n-&a}+b₁dₙ₋₁+ . . . +b_{&a}d_{n-&b} (O11)

rₙ=f₁cₙ₋₁f₂cₙ₋₂+f₃cₙ₋₃+ . . . +g₁dₙ₋₁+g₂dₙ₋₂+g₃dₙ₋₃+ (O12)

a_{n<1}=a_{n>&a}=0, f_{n<1}=0, b_{n<1}=b_{n>&a}=0, g_{n<1} =0,

fₙ=aₙ+q₁fₙ₋₁+ . . . +q_{&q}f_{n-&q}, gₙ=bₙ+q₁gₙ₋₁+ . . . +q_{&q}g_{n-&q} (O13)

Here, ‘d’ is the difference of the measurable disturbance to be fed forward. We call ‘qₙ’ controlled function, ‘aₙ’ manipulated function, and ‘bₙ’ FF function (feed forward function). COFRE is clearly an extension of M-eq. (O11) is deformed to (O12) using conversion formula (O13). The manipulated variable is calculated out as the following. We classify ‘c’, into ‘c^{P}’ and ‘c^{F}’. Here, ‘c^{P}’ is the value when ‘C’ is supposed to be kept the value of the last period and ‘c^{F}’ is the correction for settling.

c=c^{P}+c^{F} c^{P}_{n>0}=0, c^{F}_{n<0}=0 (O15)

r=qr+a(c^{P}+c^{F})+bd (O16)

We estimate the future value ‘r^{P}’ supposed ‘c^{F}=0’.

r^{P}=qr^{P}=ac^{P}=bd (O17)

Each ‘r’ and ‘r^{P}’ is represented by REFRE.

r=f(c^{P}+c^{F})+gd, r^{P}=fc^{P}+gd (O18)

We get the following expression taking the difference of (O18).

r−r^{P}=fc^{F} (019)

Because it is natural ‘R’ changes when either ‘S’ or ‘D’ changes, we request that ‘r’ is FT-settled only when ‘(bd)_{n>0}=0 and s_{n>0}=0’. Then we get the following from (O16) supposing ‘c^{F}_{n>&q}=0’.

(bd)_{n>0}=0, s_{n>0}=0, c^{F}_{n>&,q}=0 [symbol] r_{n>&q+&a}=(qr)ₙ s≡ΔS (O20)

Since ‘q’ is RFS of degree ‘&q’, ‘r_{m∈[n-&q, n-1]}=0’ makes ‘rₙ’ zero.

r_{n-&q}=r_{n-&q+1}= . . . =rₙ₋₁=0 [symbol] rₙ=0 (O21)

Therefore we request the following condition since ‘s_{n>0}=0’.

r_{n∈[&a+1, &a+&q]}=sₙ (O22)

Then ‘r_{n>&a}’ becomes zero by induction when ‘s_{n>&a}=0’. Thus FT-settling is achieved if ‘R_{&a}=S_{&a}’

$$\begin{matrix}{S}_{\& a} = {R}_{\& a} = {R}_{0} + {r}_{1} + {r}_{2} + … + {r}_{\& a} \\ = {R}_{0} + {r}_{1}^{P} + {r}_{2}^{P} + … + {r}_{\& a}^{P} + {( f {c}^{F} )}_{1} + {( f {c}^{F} )}_{2} + … + {( f {c}^{F} )}_{\& a}\end{matrix}$$

E_{&a}≡S_{&a}−R₀−r^{P}₂− . . . −r^{P}_{&a} (O24)

Fₙ≡f₁+f₂+ . . . +fₙ (O25)

Thus the simultaneous linear equation is to be solved (O26) is obtained.

F_{&a}c^{F}₀+F_{&a-1}c^{F}₁+ . . . +F_{&a-&q}c^{F}_{&q}=E_{&a} &qa=&q+&a

fₙc^{F}₀+fₙ₋₁c^{F}₁+ . . . +f_{n-&q}c^{F}_{&q}=eₙ n∈[&a+1, &qa] (O26)

eₙ≡sₙ−r^{P}ₙ (O27)

(O26) is solved concerning ‘c^{F}₀, . . . , c^{F}_{&q}’, and ‘C₀=C₋₁+c^{F}₀’ is output.

C₀=C₋₁+c^{F}₀ (O28)

While we request the condition of FT-settling only when both of the command and the disturbance are constant, (O17) and (O22) is applied to the case that the command and the disturbance are not constant. The following representation can be derived. Indeed the future values of ‘r’ can be estimated by it, additional old data are requested. It disturbs quick response after tuning and exchanging subsystem.

Z^{N}r=(1+q+q²+ . . . +q^{N-1})Z^{N}(a c+b d)+Z^{N}q^{N}r (O29)

Simulation of NACS can be performed outputting to the model system instead of the control element. In the model system, the manipulated variable can be calculated by COFRE.

R_{S i m}=q_{S i m}R_{S i m}+a_{S i m}C_{O u t}+b_{S i m}D_{S i m} (O30)

R_{S i m}, q_{S i m}, R_{S i m}, a_{S i m}, b_{S i m} and D_{S i m} are values of the model system and C_{Out} is the value calculated using the real determination system and output to the model control element. If noise made by random function is added to model values such as the manipulated variable or the measurable disturbance, the effect of noise is evaluated. The command can also be varied stepwise or polynomial curve made by random function. Instead of (O30), man can use values calculated using differential equation.

COF can be identified by regression of COFRE.

&qab≡&q+&a+&b

X_{n∈[&qab]}≡(rₙ₋₁, . . . , r_{n-aq};cₙ₋₁, . . . , c_{n-&a};dₙ₋₁, . . . ,d_{n-&b})

X≡(X₁^{T},X₂^{T}, . . . , X_{&qab}^{T}) ^{T},Y≡(r₁, r₂, . . . , r_{&qab})^{T}

COF≡(q₁, . . . ,q_{&q,a}, a₁, . . . , a_{&a}, b₁, . . . , b_{&b})^{T} Y=X·COF (O31)

COF=X⁻¹Y (O32)

Here, ‘X’ is a matrix, and ‘Y’ and ‘COF’ are vectors.

We must describe very much; nevertheless we detail NACS because there is no reference except our patent applications listed former. COFRE can be derived from the lumped real parameter linear differential equation (A-eq) through the following procedure (FIG. 3). The strict solution or integral C-eq of A-eq is obtained under the condition of digital control. The filter effects (dead time, measurement lag, transmission lag, final control element lag or statistical smoothing) are added to C-eq. This modified and expanded equation is called E-eq. And the measurable disturbance is finally added to E-eq. This equation is F-eq. The strict solution is derived combining Laplace transformation with linear algebra. Linear algebra has a fundamental theorem that the linear combination of linear combinations of ‘A’ are also a linear combination of ‘A’. A linear combination is a linear form. If ‘u’ and ‘v’ are linear forms of ‘x’ and ‘y’ then any linear form of ‘u’ and ‘v’ is linear form of ‘x’ and ‘y’. Controversially ‘x’ and ‘y’ are also linear combinations of ‘u ’ and ‘v’, if condition of independence is satisfied. If ‘x’ and ‘y’ or ‘u’ and ‘v’ are linear combinations of exponential functions or their products of polynomials and if their exponential coefficients or orders differ from each other, then they are linearly independent. The solution of A-eq can be represented using characteristic functions in convolution form. When the solution is integrated partially under the condition of digital control and transformed repeatedly using the fundamental theorem, it is changed into C-eq. Since serial procedures are all isomorphic mapping, C-eq is a difference equation of the same degree as the corresponding differential equation. Various statistical smoothing methods, which are called filters, are used in A-art. Filters are represented in linear combinations of time series. Any filter increases the degree of ‘&a’ by its degree. We have proposed noise compression substituting for filters. The cause of instability was found that it is based on the precise controllability of FT-settling, ironically. Because the controlled variable is settled perfectly in a finite time after the disturbance by FT-settling, not asymptotically, almost all time during control is under settled state. Therefore, no data can be used for tuning except when COV is changed. Almost all data is only noise. Noise doesn't act under the rule of COFRE. If many parts of operated data are used for tuning then calculated COF is broken. Therefore only data, where the difference of COV is large, can be used for the tuning. There is a disturbance called the measurable disturbance that is caused by program or can be measured. The measurable disturbance ‘D’ is included in COFRE and fed forward so that it becomes not to disturb the identification and the control. It is also noted that least-squares estimators are biased and their absolute values are smaller than the true value. The noisier the system is, the smaller the absolute values of least-squares estimators are. If COF is identified by least-squares method, the absolute values of differences of ‘C’ become larger than the true value. Therefore differences of ‘C’ is multiplied by attenuating factor considering noise. We call this art distribution of errors. NACS can avoid unstability using these methods. ‘C’ is calculated out directly from the raw value of COV so that automatic tuning is practicable. The condition for calculation is FT-settling only when ‘S’ and ‘D’ are constant.

The derivation of F-eq is described. Except non-linear control system and distributed constant system, the representation system of A-system are the combination of the state represented by a linear differential equation of real number coefficients (A-eq) and dead time.

p(s)R=a(s)C s=d/dt

p=s^{N}−Σ_{n∈[N]qn}S^{N-n}, a=Σ_{n∈[N]}aₙS^{N-n} (D01)

The following Laplace condition is supposed concerning ‘R’ and ‘C’. The condition means that the system is stationary represented zero before the start of control. If A-eq is Laplace transformed under the condition, Laplace transformation operator ‘s’ is simply substituted for ‘d/dt’.

dⁿR(t≦0)/dtⁿ=dⁿC(t≦0)/dtⁿ=0 n∈+1 (D02)

The symbols of A-system are double underlined, which correspond to symbols of D-system but whose values are different from D-system. ‘p(s)’ and ‘a(s)’ are factorised as the following.

p(s)=s^{N}−Σ_{n∈[N]}qₙS^{N-n}=Π_{m∈[N]}(s−pₘ)

a(s)=Σ_{n∈[N]}aₙs^{N-n}=a₁Π_{m∈[N-1]}(s−aₘ) (D03)

‘pm’ is called a pole, ‘aₘ’ is called a zero, and ‘s−pₘ’ and ‘s−aₘ’ are called factors. Poles and zeros are numbered in the order of the absolute values and the same values are arranged serially. ‘p’ has ‘Kₘ’ zeros that have the same values as ‘pₘ’ and ‘pₘ’ is located in the (Hₘ)th position among the same values. ‘Hₘ’ is called order of ‘pₘ’, and ‘Kₘ’ is called duplication value of ‘pₘ’. The characteristic function ‘pₘ (t)’ that corresponds to ‘pₘ’ is obtained from ‘(s−pₘ)^{-Hm}’ by Laplace reverse transformation. If a ‘pₘ’ is equal to any ‘aₘ’ then ‘pₘ’ is called common pole and ‘s−pₘ’ is called common factor. The equation that has no common factors is said irreducible. When common pole ‘pₘ’ exists, changing represented by the characteristic function ‘pₘ(t)’ cannot be measured. A-eq must be divided by all common poles and be made irreducible.

pₘ(t)=t^{Hm-1}exp(pₘt)/(Hₘ−1)! (D04)

{Π_{m∈[N]}(s−pₘ)}R(s)=(Σ_{n∈[N]}aₙS^{N-n})C(s) (D05)

f(s)≡aₙ(s)/p(s) (D06)

R(s)=f(s)C(s) (D07)

IREF ‘f(s)’ is expanded in partial fraction.

f(s)=Σ_{m∈[N]}pₘ(s−pₘ)^{-Hm}

pₘ=[d^{Km-Hm}{(s−pₘ)^{Km}f(s)/(Kₘ−Hₘ)!}/ds^{Km-}Hm]ₛ₌ₚₘ (D08)

The condition is called integral condition that ‘C’ has lower degree than ‘R’. The condition is said a kind of causality. The condition makes the above partial fraction expansion possible. Therefore that the difference of the degrees is larger than one is considered a special or accidental case. ‘pₘ’ is described in the references of control technology.

Seigyo kogaku Handobukku (Control technology handbook) p51 Asakura Shoten. ‘R(s)=f(s)C(s)’ is Laplace reverse transformed and the result is represented in convolution.

f(t)=Σ_{m∈[N]}pₘpₘ(t) (D09)

R(t)=∫₀^{t}f(x)1(x)C(t−x)dx (D10)

‘1(t)’ is unit step function. Considering the case that C(t) changes unit pulse δ (t) at t=0, f(t) is found the impulse response function (IREF).

R(t)=∫₀^{t}f(x)1(x)δ(t−x)dx=f(t) (D11)

We use the condition of digital control: ‘R’ is measured periodically and the command ‘S’ is input at the beginning of each control cycle ‘nT’. ‘C’ is calculated out using ‘R’ and ‘S’ and is output delayed by the negligible management time ‘ε’. ‘ε’ is usually neglected. ‘C’ is maintained constant until the output of the next period.

Rₙ=R(nT), Cₙ=C(nT+ε)ε≠0, ε>0 (D12)

The convolution becomes the sum of the product of ‘Cₙ₋ᵢ’ and the partial integral of ‘f(t)’. (D13) is REFRE.

Rₙ=Σ_{i∈[n]}fₙCₙ₋ᵢ=ΣᵢfₙCₙ₋₁C_{n<0}=0 (D13)

f_{n≦0}=0, f_{n≧1}=∫_{(n-1)T}^{nT}f(t)dt=Σ_{m∈[N]}pₘ∫^{nT}_{(n-1)T}pₘ(t)dt (D14)

R=fC, R={Rₙ}, f={fₙ}∈(1, ), C={Cₙ} (D15)

Since the start order of the characteristic functions is 0, ‘f’ is represented using ‘f’, whose start order is 0.

R=fΛC, fₙ≡fₙ₊₁=Σ_{m∈[N]}pₘ∫_{nT}^{(n-1)T}pₘ(t)dt=F((n+1)T)−F(nT) (D16)

F(t)≡Σ_{m∈[N]}pₘpₘ(t) (D17)

Pₘ(t)≡∫_{∞}^{t}pₘ(t)dt=exp(pₘt)Σ_{i∈H}_{ₘ}(−1)ⁱi!t^{H}^{ₘ}−i−1/(Hₘ−i−1)!pₘⁱ⁺¹ (D18)

pₘ≡exp(pₘT), p′ₘₙ≡n^{H}^{ₘ₋₁}pₘⁿ (D19)

Pₘ((n+1)T)=pₘⁿΣ_{i∈H}_{ₘ}(n+1)^{H}^{ₘ₋ᵢ₋₁}(−1)ⁱi!T^{H}^{ₘ₋ᵢ₋₁}/Hₘ−i−1)!pₘi+1 (D20)

‘Pₘ((n+1)T)’ is the product of ‘pₘⁿ’ and polynomial of ‘n’, and the maximum degree of ‘n’, is ‘Hₘ−1’. It is also a linear combination of ‘p′ₘₙ’. Since ‘F ((n+1)T)’ is a linear combination of ‘Pₘ((n+1)T)’, ‘F ((n+1)T)’ itself is also a linear combination of ‘p′ₘₙ’.

F((n+1)T)=Σ_{m∈[N]}uₘp′ₘₙ (D21)

Pₘ(nT)=pₘⁿΣ_{i∈H}_{ₘ}n^{H}^{ₘ₋ᵢ₋₁}(−1)ⁱi!T^{H}^{ₘ₋ᵢ₋₁}/(Hₘ−i−1)!pₘⁱ⁺1 (D22)

‘Pₘ(nT)’ is also the product of ‘pₘⁿ’ and polynomial of ‘n’, and the maximum degree of ‘n’, is ‘Hₘ−1’. Therefore it is also a linear combination of ‘p′ₘₙ’. Since ‘F (nT)’ is a linear combination of ‘Pₘ(nT)’, ‘F (nT)’ itself is also a linear combination of ‘p′ₘₙ’. Since ‘f’ is the difference between ‘F ((n+1)T)’ and ‘F (nT)’, it is a linear combination of ‘p′ₘₙ’. Therefore ‘f’ is a linear combination of ‘pₘₙ’, and ‘f’ is represented as the following.

F(nT)=Σ_{m∈[N]}vₘp′ₘₙ, p′ₘ≡uₘ−vₘ (D21)

f=Λ(F((n+1)T)−F(nT))=ΛΣ_{m∈[N]}p′ₘp′ₘ=ΛΣ_{m∈[N]}pₘₚₘ (D24)

pₘ=(1−pₘΛ)^{-H}^{ₘ} (D25)

p≡Π_{j∈[N]}(1−pⱼΛ) (D26)

pf=ΛΣ_{m∈[N]}pₘΠ_{j∈[N]}(1−pⱼΛ)pₘ=ΛΘ_{m∈[N]}pₘfₘ

fₘ≡(1−pₘΛ)^{K}^{_{m-H}}ₘΠₖ(1−pₖΛ)k∈{[N], pₖ≠pₘ}

∵(1−pₘΛ)^{H}^{ₘ}pₘ=1 (D27)

Considering the degrees of ‘Λ’, ‘fₘ’ are finite sequences, whose start orders are 0 and whose end orders are ‘N−Hₘ’. ‘pₘ’ are scalars, and the minimum value of ‘Hₘ’ is one. Therefore ‘pf’ is RFS of degree ‘N’.

a≡pf@a=1, &a=N∴a∈(1,] (D28)

A sequence ‘p’ is a finite sequence, the start order of which is 0 and the end order of which is ‘N’. RFS ‘q’ of degree ‘N’ is defined by (D30).

@p=0, &p=N, p₀=1 (D29)

q=-1−p@q=1, &q=N∴q∈(1,] (D30)

(1−q)R=aC∴R=qR+aC@q=1, &q=N, @a=1, &a=N (D31)

This expression is COFRE and called C-eq. And (D28) is conversion formula.

a=(1−q)f (D32)

Differing from M-eq of 0ACS, both of ‘&q’ and ‘&a’ are ‘N’. Thus the difference equation is derived as the strict solution of the differential equation. Both equations have the same degree. The case must be however considered that ‘&q’ or ‘&a’, accidentally becomes less than N. We call this degree rule Futatsugi rule. There is a correspondence of the poles between the equations. Since C-eq is a strict solution, phenomena expressed in D-system can be translated to the phenomena of A-system. Man, who uses Runge-Kutta method for the approximation in digital control theory, may be surprised with Futatsugi rule.

We considered the effect of filter hereafter. Inclined symbols mean the deformation by filter effect. At first, we consider effects of measurement lag or statistical treatments/smoothing (weighted average). The lag and average can be represented as the following, where ‘R’ is the calculated value, ‘R’ is the true value, ‘W’ is weight sequence, and ‘M’ is the degree of the filter.

R=Σ_{k∈M+1}WₖΛ^{k}R, Σ_{k∈M+1}Wₖ=1, W=Σ_{k∈M+1}WₖΛ^{k}

=Σ_{k∈M+1}WₖΛ^{k}(qR+aC) =qR+aC (D33)

a≡W·a@a=1, &a=&a+M (D34)

Thus ‘&a’ is increased by ‘M’. But ‘&q’ remains constant. We consider a filter to estimate the present value using the measured value. For simplicity, not-weighted filter is took an example. The controlled variable of ‘m’ periods before is ‘R₋ₘ’. The regression coefficient of the straight line is the following. Bracket < > means the mean value.

R=k(n−<n>)+<R><n>=M/2, <R>=Σm∈M+1R₋ₘ/(M+1),

k=6Σ_{m∈M+1}(2m−M)R₋ₘ/M(M+1)(M+2) (D35)

The present value is given when ‘n’ is 0.

R(0)=<R>−k<n>=2Σ_{m∈M+1}{(2M+1−3m)/(M+1) (M+2)}R₋ₘ (D36)

The expression using sequences is the following.

R=WR=WqR+WaC=qR+aC, a=Wa, &a=&a+&W=&a+M

W=Σ_{m∈M+1}WₘΛ, Wₘ≡2(2M+1−3m)/(M+1) (M+2) (D37)

Thus, even the filter to estimate the present value similarly increases ‘&a’ by ‘MS’. This filter is used in the above-mentioned reference “,Sugaku semina”. The reason why ‘&a’ must be more than twenty was the result of high degree filter. Therefore, the noise reduction art is necessary for FT-settling instead of filter.

We consider output lag. There are cases that the calculation time for the manipulate variable is not negligible or that the manipulated value can not change at one time. The aperture of a pulse valve can be changed only slowly. The temperature should not be changed rapidly in crystal growth. In these cases, the manipulated variable is changed along a zigzag line that connects calculated values of the manipulated variable at each period. The effective output ‘C’ is the mean value of the neighboured two periods. In stead of a zigzag line, the manipulated variable can be output along a polynomial curve of degree ‘M’ connecting ‘M+1’ past and present data points. As known, the manipulated variable of these cases is also represented by a filter of degree ‘M’. ‘M=1’ is the case of a zigzag line.

C=Σ_{k∈M+1}WₖΛ^{k}C, Σ_{k∈M+1}Wₖ=1, W=Σ_{k∈M+1}WₖΛ^{k} (D38)

R=qR+aC=qR+aWC=qR+aC (D39)

a≡aW@a=1, &a=&a+M (D40)

In these cases, only ‘&a’ is increased by M, too. Avoiding from the increase of the degree, the manipulated variable must be output stepwise as far as possible.

Thus filters increase ‘&a’ and maintains ‘&q’ constant. Even when a filter is used, its degree must be as low as possible.

We consider the effect of dead time. Its effect is similar to a filter of the manipulated variable. In a pipeline system, the response is delayed by the time ‘M·T’ to transport from the manipulated point to the controlled point. COFRE with dead time can be represented by ‘C’ without dead time.

C=CΛ^{M}, R=qR+aC=qR+aC, W=ΛM (D41)

a≡aW &a=&a+M (D42)

Thus only ‘&a’ is increased by ‘M’.

All these effects increase only ‘a’. C-eq and M-eq increased ‘&a’ are called E-eq.

R=qR+aC &q≦&a (D43)

Disturbances that are caused by program or that can be measured also cause changing of the controlled variable. These disturbances are called measurable disturbances and given symbol ‘D’. Though there can be many measurable disturbances in a system, these are represented by only one disturbance for simplicity. A measurable disturbance can be included in NACS-set so that its bad effect is avoided, the controllability is improved, and the identified COF is avoided from destruction by the disturbance. This art is called FF (feed forward). The following expression (B-eq) is derived from A-eq using principle of superposition of a measurable disturbance.

(S^{N}−Σ_{n∈[N]}qs^{N-n})R

=(Σ_{n∈[N]}ans^{N-n})C+(Σ_{n∈[N]}bₙs^{N-n})D (D44)

Supposed not only ‘C’ but ‘D’0 also change stepwise periodically, the following difference equation D-eq is derived similarly to the derivation of C-eq.

R=qR+aC+bD &q=&a=&b=N (D45)

Indeed the measurable disturbance can be varied continuously unless it is caused by program. This continuous variation can be approximated by a polynomial curve of degree ‘%b’. This means that ‘D’ has a filter of degree ‘%b’, and ‘&b’ is increased by ‘%b’. The degree of stepwise variation is 0 and zigzag line variation 1. ‘%b’ is called degree of continuity. Since ‘D’ is not generally fed forward in PID control, small ‘%b’ value such as 0 or 1 suffices many cases. Filters for ‘R’ increase ‘&a’ and ‘&b’, filters for ‘C’ increase ‘&a’, and filter for ‘D’, increase ‘&b’. D-eq and M-eq are changed into F-equation considering various filtering effects.

R=qR+aC+bD &q≦&a, &q≦&b (D46)

We must consider the cases ‘aₙ=0’ and ‘bₙ=0’ that accidentally happen. Then F-equation is expanded to general COFRE (FIG. 3).

R=qR+aC+bD q,a,b∈(1,] (S48)

Using the following conversion formula, REFRE is derived.

f=a/(1−q), g=b/(1−q) (D47)

R=fC+gD f,g∈(1,) (D48)

When there are M measurable disturbances, COFRE and REFRE are represented as the following.

R=qR+aC+b₁D₁+b₂D₂+ . . . +b_{M}D_{M} (D49)

R=fC+g₁D₁+g₂D₂+ . . . +g_{M}D_{M} (D50)

a=(1−q)f, b_{m∈[M]}=(1−q)gₘ (D51)

But these are represented by the expression of one measurable disturbance for simplicity. COFRE and REFRE is deformed multiplied by Δ.

r=qr+ac+bd r≡ΔR, c≡ΔC, d≡ΔD (D52)

r=fc+gd (D53)

Each of (D52) and (D53) is called COFRE and REFRE, too. While both C-eq and D-eq have the corresponding differential equations A-eq and B-eq, but E-eq, F-eq, and M-eq have no corresponding differential equations. The 0th order of COV means the watched period such as the present time hereafter unless mentioned specially.

Stability of NACS is described.

A-art has usually the determination system q independent from the representation system Ψ. Ψ is propagation equation and Φ is PID system, for example.

R=Ψ(C;t), C=Φ(R,S;t) (A01)

‘R’, which is changed by ‘C’ calculated by Φ, is considered by Ψ.

R=Ψ(Φ(R,S;t);t)=Ξ(R,S;t) (A02)

This representation is called a loop transfer function. Using it, it is studied how ‘R’ is approaching to ‘S’. Ant it is called stable, that ‘R’ approaches to finite ‘R(∞)’. The parameters of the system are determined so that the system is stable. The manipulated variable is calculated out so that the controlled variable agrees perfectly with the command within a finite delay in the determination system in the system of FT-settling.

R=Ξ(R,S;t≧tnT)=S (A03)

Therefore the system is absolutely stable as long as that the representation system is correct. The stability of the FT-settling is not referred in the above mentioned references concerning 0ACS ‘Shisutemu to seigyo’ and ‘Sugaku semina’. An investigation using loop transfer function is only fruitful when AS-settling is adopted as the determination system or the real representation system is different from the representation system of the determination system. The representation system of 0ACS has a poor theoretical background. But, the representation system of NACS is based on a steady theoretical background.

Stability of automatic tuning in A-art is investigated as Robust-adaptive system. This system uses the loop transfer function combined with the tuning system where parameters of the determination system are identified. And the convergence of the parameters is investigated in the loop including the tuning system. Namely, both of the stability or convergence of the controlled variable and the stability or convergence of the tuning parameters are considers. When both stability are stable, the system is called ‘robust’. The control gain is taken for the stability index of the controlled variable in robust theory. Robust-stability of NACS is examined by the following COFRE.

rₙ=q₁rₙ₋₁+ . . . +q_{&q}r_{n+&q}+a₁cₙ₋₁+ . . .

+a_{&a}c_{n-&a}+b₁dₙ₋₁+ . . . +b_{&b}d_{n-&b} (A04)

Such case is considered that both command and the measurable disturbance are independently changed and ‘&qab’ sets of tuning data are obtained. Then the data sets are linear independent and COF can be calculated out (A09).

&qab≡&q+&a+&b (A05)

X_{n∈[&qab]}≡{rₙ, rₙ₋₁, . . . , r_{n-&q};Cₙ₋₁, . . . , C_{n-&a};dₙ₋₁, . . . , d_{n-&b}} (A06)

COF≡(q₁, . . . ,q_{&q},a₁, . . . ,a_{&a},b₁, . . . ,b_{&b})^{T} (A07)

X≡(x₁^{T}, x₂^{T}, . . . , x_{&qab}^{T})^{T}, Y≡(r₁, r₂, r_{&qab})^{T}, Y=X·COF (A08)

COF=X⁻¹Y (A09)

Here ‘^{T}’ means transpose and ‘⁻¹’ inverse matrix. Thus, as soon as tuning data ‘X’ is completed, COF is identified and determined. Thereafter all COV is the same as or newer than what are used for identification. Therefore NACS is robust within the finite time of the completion of data in the order of measurement precision.

Least-squares method is adopted in many real operations to improve precision. When each ‘X’ and ‘Y’ is the above mentioned matrix and vector added new data, COF is calculated by least-squares method.

COF=(X^{T}X)⁻¹(X^{T}Y) (A10)

‘M_{X’, ‘Y}_{X}’ and ‘S_{Y}’ are used instead of ‘X^{T}X’, ‘X^{T}Y’ and ‘Y^{T}Y’ in the case that new data are endlessly added.

M_{X}=X^{T}X, Y_{X}=X^{T}Y, S_{Y}=Y^{T}Y (A11)

We let the (N^{ID})th data be ‘x’ and ‘y’. ‘p^{Id}’ is called renovation rate.

N^{ID}=N^{ID}+1, if N^{MAX}<N^{ID} then N^{ID}=N^{MAX}

p^{Id}≡1/N^{ID}, x=(r₋₁, . . . , r_{-&q}, c₋₁, . . . , c_{-&a}, d₋₁, . . . , d_{-&b}); y=r₀ (A12)

New data are added to ‘M_{X}’, ‘Y_{X}’ and ‘S_{Y}’ using ‘p^{ID}’ so that data are exchanged by ‘p^{ID}’ in each renovation.

M_{X}→M_{XX}+p^{ID}(x^{T}x−M_{X}), Y_{X}→Y_{X}+p^{ID}(yx^{·T}−Y_{X,}

S_{Y}S_{Y}+p^{ID}(y²−S_{Y}) (A13)

COF and ‘ER’ are calculated using ‘M_{X’, ‘Y}_{X}’ and ‘S_{Y}’.

COF=M_{X}^{-Y}_{X}ER²=S_{Y}−k^{T}Y_{X} (A14)

Each of ‘M_{X}’, ‘Y_{X’, and ‘S}_{Y}’ is called respectively ‘tuning matrix’, ‘tuning vector’, and ‘tuning deviation’. And the set of ‘M_{X}’, ‘Y_{X}’, S_{Y}’, ‘N^{ID}’ is called ‘tuning set’, and ‘x and y’ are called tuning data. ‘M_{X}⁻’ means the approximate inverse matrix of ‘M_{X}’ when ‘M_{X}’ is not regular, and it means the inverse matrix when ‘M_{X}’ is regular. ‘ER²’ is residual sum of squares divided by ‘N^{ID}’.

ER²˜_{Σ}_{n∈N}E₋ₙ²/N^{ID}Eₙ=Rₙ−(qR+aC+bD)ₙ

σ²˜_{Σn∈N}E₋ₙ²/(N^{ID}−M^{ID}) M^{ID}≡&qab (A15)

While the expectation of variance ‘σ²’ is error mean square, ‘ER²’ is regarded as variance when ‘N^{ID}’ is large. ‘ER’ is square root of ‘ER²’. When the system varies as it elapses, renovation rate must not be extinguished. When ‘N^{ID}’ exceeds fixed value ‘N^{MAX}’, which is usually set 100˜1000, ‘N^{ID}’ is kept constant ‘N^{MAX}’ (A12). When ‘N^{ID}’ is one, ‘p^{ID}’ is also one and old data become invalid. When data is not completed, ‘M_{X}’ is not regular and inverse matrix ‘M_{X}⁻¹’ cannot be calculated. When man cannot wait till ‘M_{X}’ becomes regular, approximate inverse matrix is calculated. Sweep out method is well known to calculate inverse matrix. When the matrix is not regular, diagonal element(s) exist(s) that is/are 0, even if the row(s) is/are exchanged. In such case(s), the diagonal element(s) is/are remained 0 and the procedure is continued. The matrix, which is calculated by this method, is called approximate inverse matrix. The approximate inverse matrix is of cause the inverse matrix if the matrix is regular. Even if data for ‘b’ are lacked when data for ‘q’ and ‘a’ are completed, ‘q’ and ‘a’ can be calculated by this method. This situation can occur when the measurable disturbance cannot be caused intentionally and man cannot wait for changing of the disturbance. In this case, ‘b’ is normally regarded as zero sequence and the measurable disturbance is not fed forward till ‘b’ is identified.

Thus NACS has no factor of unstability by the classical concept. But unstability of 0ACS (including NACS without counterplan against unstability) is observed in fact. Why does the unstability occur? Analysing the data of operations and repeating simulations, the following fact is discovered. Only COF identified by the data of 0ACS or NACS operation causes unstability some times in the first stage of operation, and COF identified by the data of PID-operation doesn't cause unstability. The controlled variable is perfectly settled in a few periods after disturbance in FT-settling, only noise is observed thereafter. Large noise cause sometimes not-negligible variance, which. is disappeared soon. Noise doesn't obey the rule of COFRE. Only very small part of data of 0ACS is suitable for tuning. Therefore identified CAF is destroyed if large part of data is used for tuning. And not large part of data can destroy CAF when CAF is identified very well and the command is not changed frequently. In AS-settling of PID, the controlled variable varies for a long time after the change of command or the occurrence of disturbance. This variance can be represented by COFRE. The variance continues for a while, and it can be represented by COFRE. Therefore not small part of data of PID is suitable for tuning. We took the following counterplan against unstability.

CAF is identified using data just after when the controlled variable, the command, the manipulated variable or the measurable disturbance change largely compared with noise.

The disturbances, whose values can be obtained, are positively fed forward.

The disturbances, whose values cannot be obtained, such as emergency stop are input from the special end. The reserved CAF are substituted for the CAF, which are then identified. And CAF are not identified till such case ceases and the stable state is confirmed.

Magnitudes of signals of the manipulated variable, and the measurable disturbance are defined by the absolute value of each difference converted to the controlled variable. Namely, magnitude's of signals are ‘|r₀|’, ‘s_{&a}|’, ‘|c₀·&a/A_{&a}|’ and ‘|d₀·&b/B_{&b}|’. Here ‘A_{&a}/&a’ and ‘B_{&b}/&b’ are mean values of ‘aₙ’ and ‘bₙ’ respectively. The magnitude of noise ‘N0I’ is estimated by the square root of the sum of error mean square and the square of digital error.

h≡|r−qr−ac−bd|h₀=|(r−qr−ac−bd)₀|=|r₀−q₁r₋₁₋. . .

−q_{&q}r_{-&q}−a₁c₁− . . . −a_{&a}c_{&a}−b₁d₋₁− . . . −b_{&b}d_{-&b}| (A16)

N^{NS}←N^{NS}+1, if N^{NS}>N^{MAX} then N^{NS=}N^{MAX}

p^{NS}=1/N^{NS}, N0I²←N0I²+p^{NS}(h₀²+DGT²−N0I²) (A17)

Here, ‘p^{NS}’ is renovation rate for noise level and ‘N^{MAX’ is set ‘}100˜1000’. We call ‘h’ an estimation gap. It is absolute value of the error between estimation and measurement. And ‘DGT’ is digital error namely precision of AD-converter for measurement of the controlled variable. When one of signal noise ratio ‘S/N’ exceeds the criterion (S/N)_{Lim}, which is determined beforehand, it is judged that a large signal happens. Then identification starts. If the signal concerns the command or the manipulated variable then data of more than ‘&qa’ periods after the large signal are used. Else if it concerns the measurable disturbance then data of more than ‘&q+&b’ periods are used. And if it concerns the controlled variable then data of more than ‘&q’ periods are used.

In settled state, ‘c’ is excited by noise of ‘r’ and noise is amplified by control gain. The stability of the controlled variable is indicated by control gain in robust adaptive system, therefore. White noise is considered to obey normal distribution, and to seldom exceed the three times standard deviation ‘3σ’ and to almost never exceed the five times standard deviation ‘5σ’. The magnification factor ‘k_{Dis}’ is let more than three. When control error is less than ‘k_{Dis}’ times of ‘N0I’, ‘c₀’ is com pressed to ‘c₀’.

E₀=S_{&a}−R₀ (A18)

k_{Com}=k_{Res}+(1k_{Res})E₀²/(E₀²+k_{Dis}²N0I²) (A19)

c0=k_{Com}·c₀C₀=C₋₁+c₀ (A20)

‘k_{Res’ is residual compression factor when control error ‘E}₀’ is almost 0 namely in settled state, and ‘k_{Com}’ is real compression factor. This method is called noise compression. According to statistics, the standard deviation of the average of M samples is ‘σ/√F(M−1)’. When ‘k_{Res}’ is let ‘⅓’, noise compression has the effect of average of ten samples in settled state. Therefore ‘k_{Res}’ is usually taken ‘10.2·0.4’. This method doesn't increase ‘&a’ and doesn‘t disturb the settling because it works only in settled state.

Method of least-squares is a very useful art that gives maximum likelihood estimates, but is gives only biased estimator. We consider three points (−1,−1), (0,1) and (1,0) in X−Y coordinate. Since these points locate symmetry to X and Y, the regression line is expected ‘Y=X’. But the least-squares regression line is ‘Y=(σ_{XY}/σₓ²)X=(½)X’. Correlation coefficient is σ_{XY}/σ_{X}σ_{Y}=½’. Least-squares estimates are generally the unbiased estimator multiplied by the absolute value of correlation coefficient. The absolute value of correlation coefficient ‘k’ becomes small when noise is large, and its maximum value is one. Let's consider the case that ‘k’ equals nearly one. Namely noise is small. All ‘q’, ‘a’ and ‘b’ are least-squares estimated using COFRE.

r=qr+ac+bd (D52)

Since ‘q’, ‘a’ and ‘b’ are true values multiplied by ‘k’, ‘f’ and ‘g’ are nearly equal to true values multiplied by ‘k’.

a=(1−q)f, b=(1−q)g (S49)

If ‘d’ is ‘0’ then ‘c’ is calculated true value divided by ‘k’.

r=fc+gd [symbol] c=(r−gd)/f (A21)

Since ‘k’ is a positive value less than one, calculated ‘c’ is larger than true value and excess control is caused. Even if COF is estimated by other method, for example sequence estimation, noise causes excess control in some rate. Excess control induces overshoot. In order to avert this, calculated ‘c’ is multiplied by a reduction factor ‘k_{RD}’.

c₀=k_{RD}c₀, C₀=C₋₁+c₀ (A22)

The factor ‘k_{RD}’ can be the above mentioned absolute value of correlation coefficient ‘k’ if it is calculated. It is almost one but less than one in many cases (k_{RD}=0.98˜0.99). Man can also determine it by trial and error observing the controlled state. We call this method ‘distribution of errors’, since this method has been thought out investigating fractions of error. Distribution of errors can be combined with noise compression as the following.

E₀=S_{&a}−R₀ (A19)

k_{CRD}=k_{Com}·{k_{Res}+(1−k_{Res})E₀²/(E₀²+k_{DIS}²N0I²)} (A20)

c₀=k_{CRD}c₀C₀=C₋₁+c₀ (A22)

‘N0I, k_{Com}, k_{Res}, k_{Dis}’ are called noise parameters. However both of noise compression and distribution of errors are unnecessary when noise is negligible. Then parameters are set ‘k_{Res}=k_{Com}=1’.

We consider the case of excessively short control period. The main purpose of such case is considered the fastest settling time. We use a model that is similar to Ziegler-Nichols model and neglect the measurable disturbance. When control period is short, SREF has a slow rising part in many cases. Ziegler-Nichols model represents it well. Therefore the rising part ‘f_{n<M}’ before the settling time is regarded as negligible and these are included in ‘f_{M}’.

f_{n<M}≠0, f_{M}←f₁+f₂+ . . . +f_{M} (A23)

We calculate ‘c’, which makes ‘r’ agree with ‘s’ after M periods . . .

r_{n≧M}=sₙ=Σ_{i ≧M}fᵢcₙ₋ᵢ

s_{M}=f_{M}c₀+f_{M+1}c₋₁+f_{M+2}c₋₂+ . . . +f_{M-@c}C@c

S_{M+1}=f_{M}c₁+f_{M+1}c₀+f _{M+2}c₋₁+ . . . +f_{M-@c+2}c_{@c}

s_{M+2}=f_{M}c₂+f_{M+1}c₁+f_{M+2}c₀+ . . . +f_{M-@c+2}c_{@c} (A24)

Because ‘c_{n<0}’ are known, ‘c_{n≧0}’ can be calculated. We, however, suppose that the system have been in steady-state under ‘S=0, C=0, ’ and ‘S’ is changed now, for simplicity.

c_{n<0}=0, s_{M}≠0, s_{n>M}=0 (A25)

c₀=s_{M}/f_{M},

c₁=(f_{M+1}/f_{M})s_{M}/f_{M},

c₂={(f_{M+1}/f_{M})²⁻(f_{M+2}/f_{M}))}(s_{M}/f_{M}),

c₃={−(f_{M+1}/f_{M})³+2(f_{M+1}/f_{M}) (f_{M+2}/f_{M})−(f_{M+3}/f_{M})}(s_{M}/f_{M}) (A26)

All ‘cₙ’ have factors ‘(f_{M+1}/f_{M})ⁿ’ and products of (f_{M+n}/f_{M}). Exponential function has an infinite radius of convergence since the coefficients of factors converge to zero rapidly. But the coefficients of factors are integer in this case. The radius of convergence is considered ‘1’. Therefore ‘cn’ diverge unless the absolute value of ‘f_{M}’ is the maximum among ‘f_{n’. When the maximum of ‘f}ₙ’ is ‘f_{N}’ ‘N’ is called the peak time. Indeed the calculation method of NACS is not the same as this method. This model indicates that the settling within the peak time can make the system unstable or noisy. The future interval until the peak time is called ‘excessively near future’.

As mentioned above, NACS is a very precise control system. But there are some problems. Since ‘c’ is calculated only for ‘S’ and future value of ‘R’ must be estimated in each period, it is difficult to adapt to the complex system. The most convenient form of COFRE is single pole representation for the conventional NACS. But its applicable region is not clear. And ‘&a’ and ‘&b’ cannot be determined theoretically. Moreover, new unstability has been found. When the system is controlled by the third strong power that is not fed forward, the system falls into unstability. It is very natural. But, in order that automatic tuning system can substitute the system without automatic tuning system, this problem must be solved.

### DISCLOSURE OF THE INVENTION

(1) The degree of COF equals the degree of differential equation without filter effect. We have found also the degree ‘M’ can be less than or equal ‘5’ as long as the control period is proper. The system can be approximated by single pole representation unless it is an oscillator. And both ‘&a’ and ‘&b’ of single pole representation, which corresponds lag of order M, is ‘2M-1 without filter effect. Thus we can now estimate the maximum degree of COF in both case of single pole representation and plural poles representation. We call this art degree systemisation. (FIG. 11)

(2) While FT-settling is the settling in a finite time, FT-manipulating is newly defined to make the manipulated variable constant after a finite time and FT-determining is also newly defined that both of FT-settling and FT-manipulating are satisfied. We must confirm that FT-settling is not always FT-manipulating. The manipulated variable can be calculated directly solving COFRE under the condition of FT-determining. And the formula of the solution is a linear form of COV.

(3) Automatic tuning is carried out classified into three phases namely response test phase (test phase), fast tuning phase (fast phase), and normal tuning phase (normal phase). And we define five events: Command event, liberation event, feed forward event (FF event), oscillation event, and saturation event. The former three events can start tuning in normal phase, and all five events can start tuning in fast phase. All five events are the condition that COF can be identified above the fixed precision using the data from the next period of the event to the ‘&qa’ periods after. When the system is operated for the first time then it starts in test phase. And the control period and COF are identified for each subsystem. The terms that are negligible considering the precision are omitted and the degree of COF is determined. Of course the system can enters into test phase if necessary and unnecessary procedures can be omitted. When test phase ends, the system enters into normal phase. When the system is restarted it begins in fast phase. Manual request can let the system enter into fast phase. And the signal of subsystem exchange can also let the system enters into fast phase when COF of new subsystem has not been checked. In fast phase, it is examined if the subsystem is changed. Destroyer event is defined that estimation gap exceeds noise level clearly. And it is always watched in fast phase and in normal phase. If destroyer event happens in fast phase, it is judged the system is exchanged and COF is wrong. And newly obtained tuning set is substituted for tuning set including the data of the last operation and the system enters into normal phase when data is completed. If it is judged that the system is not changed then the system enters into normal phase as it is. This art is called fast tuning. Destroyer event is understood in normal phase that not-measurable disturbances occur that are clearly greater than noise level. The tuning set is not reliable when destroyer event happens. Old reliable set is substituted for such set. The system recovers stability again when the not-measurable disturbance is removed. Tuning is restarted after the confirmation that not-measurable disturbance doesn't occur so frequently. If system is unstable then optional safety program runs. The system is stopped outputting alarm for example. We call this art tuning diagnosis. The identification of COF is carried out for all subsystem in both of fast phase and normal phase if COV of all subsystem can be observed all time.

The background of single representation is given and the degree of COF can be determined automatically. As mentioned in the background art, the difference between ‘&a’, and ‘&b’ depends on each filter. Filter effect concerning ‘R’ increases ‘&a’ and ‘&b’, that concerning ‘C’ increase only ‘&a’, and that concerning ‘D’ including degree of continuity increases ‘&b’ only. The control period is determined so that COF can be identified above the fixed precision. ‘Cₒ’ can be calculated by a linear form of COV, which is derived solving COFRE under FT-determining. The calculation becomes simpler than previous NACS. And used data range is changed. COF is identified by regression of COFRE as the same as the conventional method. The identification is carried out only when it is judged that COF is identified above the fixed precision and destroyer event doesn't happen. The judgement is made by estimation of noise so that the system is maintained stable. The previous criterions using noise level are only concerning above ‘3σ’. In addition, new criterions are defined concerning the precision. Selection of tuning data is strictly limited compared with the previous NACS. And disturbance of not fed forward is automatically detected as destroyer event and it can be avoided. The conventional NACS sticks to 0ACS too much.

For simplicity, we consider omitting ‘b’ for a while. We call poles of A-system A-poles, and poles of D-system D-poles. We consider the system that energy theorem is satisfied. The real parts of A-poles are negative, and the absolute values of D-poles are smaller than one. Each D-pole ‘Pₘ’ is represented using real part ‘−Pₘ_{^{R’ and imaginary part ‘P}}ₘ_{^{1’ of A-pole.}}

Pₘ=−Pₘ_{^{R+j·P}}ₘ_{¹}0<Pₘ_{^{R}} (M01)

Pₘ=exp(j·Pₘ_{^{1T}})exp(−Pₘ_{^{RT}}) (M02)

We consider of the control period ‘T’. If ‘Pₘ’ is real number, then ‘Pₘ’ is also positive real number. And if ‘Pₘ’ is imaginary number, then ‘Pₘ’ is real number only when ‘Pₘ_{^{1T’ is integer times ‘π°. This case is special an accidental. Even when a D-pole is real number, it is regarded as an imaginary D-pole if corresponding A-pole is imaginary number. As ‘T’ increases, the absolute values of ‘P}}ₘ’ decrease exponentially, so that D-poles of large ‘Pₘ_{^{R’ can be regarded as zero and neglected. Finally, M poles remains.}}

1−q≠Π_{m∈[M]}(1−pₘΛ) (M03)

We consider this state by the differential equation. That the period ‘T’ is increased in D-system is equivalent that changing in the interval shorter than ‘T’ is neglected in A-system. And that D-poles asymptote to zero corresponds to that real parts of A-poles diverge to −∞.

p(s)R=a(s)C f(s)=a(s)/p(s)

p(s)=s^{N}−Σ_{n∈[N]}qₙs^{N-n}=Π_{m∈[N]}(s−pₘ)

a(s)=Σ_{n∈[N]}aₙs^{N-n}=a₁Π_{ne[N-1]}(s−aₙ) (M04)

A-eq must be divided by all common poles to be irreducible. It is called degeneration that the degree of the differential equation decreases by the generation of a new common pole. We investigate the case that real part of ‘pₘ’ becomes to −∞ as ‘T’ increases. A-eq is divided by ‘(−1)^{N}q_{N}=Π_{n∈[N]}pn’ so that the constant term becomes ‘1’.

p′(s)R=a′(s)C

p′(s)=Σ_{n∈N}p′ₙS^{N-n}+1=Π_{m∈[N]}{1−(s/pₘ}

a′(s)=Σ_{n∈[N]}a′ₙs^{N-n}=a′_{N}Π_{n∈[N-1]}{1−(s/aₙ)} (M05)

When one ‘pₘ’ exists, which diverges to −∞, the degree of ‘p′ (s)’ decreases by one (∵(1/pₘ→0), and the degree of ‘a′ (s)’ also decreases by one because of integral condition. Namely, one ‘1/aₙ’ becomes 0. In the same time, one common factor ‘(1−pₘΛ)=(1−aₙΛ), pₘ=aₙ=0’ is generated in C-eq, the degree of C-eq decreases by one, and both degrees of A-eq and C-eq keep the same.

{Π_{m∈[M]}(1−pₘΛ)}R=a₁{Π_{n[∈M-1]}(1−aₙΛ)}C (M06)

Thus the degree of C-eq decreases if the control period is long. If only imaginary poles remain, the system is an oscillator. It is difficult to be approximated by single pole representation unless C-eq is rewritten so that ‘R’ means the amplitude of oscillation. When only one real pole remains, C-eq itself is single pole representation. It is the case that the system is easily controlled by PID. Therefore we consider the case that more than two real poles remain. When M poles remain, the system is called lag of order M. If variation exist among poles, small poles can be neglected when the control period elongates a little. Therefore, remained poles can be considered to have almost the same value.

p_{M}=exp(−p_{M}_{^{RT}}), Pₘ={n^{m-1}p_{M}ⁿ}_{@=0} (M01)

The maximum order of ‘Pₘ’ is about ‘−(m−1) /log(p_{M})’. All characteristic functions ‘Pₘ’ decrease at the right side of ‘−(M−1) /log(p_{M})’. We make the settling period ‘&a=M’ to locate the right side of the peak.

−(M−1)/log(p_{M})≦M pₘ≦e^{-(M-1) /M} (M02)

M=2→p_{M}≦0.61, M=3→p_{M}≦0.51, M=4→p_{M}≦0.47

M=5→p_{M}≦0.45, M=6→p_{M}≦0.43, M=∞→p_{M}≦0.368 (M03)

The decrement part of single pole representation is described by simple exponential function. The decrement part of lag of order M is not simple exponential function. And the larger M is, the more complex the part is. Therefore we try to make approximation under the condition (M04) which is stricter than (M02)(M03).

q₁=M·P_{M}≠1, p_{M}≠1/M M≦2 (M04)

R=qR+aC, &q=&a=M, 1−q=(1−p_{M}Λ)^{M} (M05)

(1−q_{M}_{¹}Λ)R=a_{M}C (M06)

a_{M}≡a(1−q_{M}_{¹}Λ)/(1−p_{M}Λ) ^{m}=a(1−U_{M}) (M07)

$$\begin{matrix}{U}_{\underline{M}} ≡ 1 - ( 1 - {q}_{{M}^{1}} Λ ) {\underline{\sum }}_{n ∈ [ 0 , + ∞ ]} ( M + n - 1 ) ! {( {p}_{M} Λ )}^{n} / ( M - 1 ) ! n ! \\ = 1 - {\underline{\sum }}_{n ∈ [ 0 , + ∞ ]} \{ ( M + n - 1 ) ! {( {p}_{M} Λ )}^{n} / ( M - 1 ) ! n ! - \\ ( {q}_{{M}^{1}} / {p}_{M} ) ( M + n - 1 ) ! {( {p}_{M} Λ )}^{n + 1} / ( M - 1 ) ! n ! \}\end{matrix}$$

g_{M}≡Mq_{M}_{¹}/q₁=q_{M}_{¹}/p_{M} (M09)

$$\begin{matrix}{U}_{\underline{M}} = - {\underline{\sum }}_{n ∈ [ + ∞ ]} \{ ( M + n - 1 ) ! {( {p}_{M} Λ )}^{n} / ( M - 1 ) ! n ! - \\ {g}_{\underline{M}} {\underline{\sum }}_{n ∈ [ + ∞ ]} ( M + n - 2 ) ! {( {p}_{M} Λ )}^{n} / ( M - 1 ) ! ( n - 1 ) ! \} \\ = - {\underline{\sum }}_{n ∈ [ + ∞ ]} \{ ( M + n - 1 ) ! {( {p}_{M} Λ )}^{n} / ( M - 1 ) ! n ! - \\ {g}_{\underline{M}} {\underline{\sum }}_{n ∈ [ + ∞ ]} n ( M + n - 2 ) ! {( {p}_{M} Λ )}^{n} / ( M - 1 ) ! n ! \} \\ = - {\underline{\sum }}_{n ∈ [ + ∞ ]} ( M + n - 1 - {g}_{\underline{M}} n ) ( M + n - 2 ) ! {( {p}_{M} Λ )}^{n} / \\ ( M - 1 ) ! n !\end{matrix}$$

@U_{M}=1 (M11)

‘U_{M}’ and ‘q_{M}_{¹}’ are calculated as the following for ‘M=2˜10’ under the condition ‘q₁=1’ and ‘g_{M}’ are (M12).

g₂=1.5, g₃=1.6, g₄=1.6, g₅=1.6, g₆=1.6,

g₇=1.6, g₈=1.6, g₉=1.6, g₁₀=1.6 (M12)

q₂_{¹}=0.75, q₃_{¹}=0.53, q₄_{¹}=0.40, q₅_{¹}=0.32, q₆_{¹}=0.27,

q₇_{¹}=0.23, q₈_{¹}=0.20, q₉_{¹}=0.18, q₁₀_{¹}=0.16 (M13)

$${U}_{\underline{2}} = \{ 0.250 , 0.000 , - 0.062 , - 0.062 , - 0.047 , - 0.031 , - 0.020 , \\ - 0.012 , - 0.007 , … \}$$

$${U}_{\underline{3}} = \{ 0.467 , 0.133 , 0.015 , - 0.012 , - 0.012 , - 0.008 , - 0.004 , \\ - 0.002 , - 0.001 , … \}$$

$${U}_{\underline{4}} = \{ 0.600 , 0.225 , 0.063 , 0.012 , - 0.000 , - 0.001 , - 0.001 , \\ - 0.000 , - 0.000 , … \}$$

$${U}_{\underline{5}} = \{ 0.680 , 0.280 , 0.088 , 0.022 , 0.004 , 0.001 , - 0.000 , \\ - 0.000 , - 0.000 , … \}$$

$${U}_{\underline{6}} = \{ 0.733 , 0.317 , 0.104 , 0.028 , 0.006 , 0.001 , 0.000 , \\ 0.000 , - 0.000 , … \}$$

$${U}_{\underline{7}} = \{ 0.771 , 0.343 , 0.114 , 0.031 , 0.007 , 0.002 , 0.000 , \\ 0.000 , 0.000 , … \}$$

$${U}_{\underline{8}} = \{ 0.800 , 0.363 , 0.122 , 0.034 , 0.008 , 0.002 , 0.000 , \\ 0.000 , 0.000 , … \}$$

$${U}_{\underline{9}} = \{ 0.822 , 0.378 , 0.128 , 0.035 , 0.008 , 0.008 , 0.000 , \\ 0.000 , 0.000 , … \}$$

$${U}_{\underline{10}} = \{ 0.840 , 0.390 , 0.132 , 0.036 , 0.008 , 0.002 , 0.000 , \\ 0.000 , 0.00 , … \}$$

Namely with precision of 6% for lag of order 2, with precision of 2% for order 3˜4, ‘Um’ can be approximated by RFS of degree ‘&U_{M}=&q−1’ . Then &a_{M}=&a+&U_{M}’. Since ‘&q_{M}=1’, ‘&a_{M}+&q_{M}’ agrees with ‘&qa’.

M≦4 [symbol] &qa=&a_{M}+&q_{M} (M15)

With precision of 1% for lag of order higher than ‘4’, ‘U_{M}’ can be approximated by RFS of degree ‘4’.

5≦M [symbol] &U_{M}=4 (M16)

We notice that almost all ‘U_{M>4}’ resemble each other. Considering integral condition, this result suggests ‘q’ and ‘a’ can be approximated by RFS of low degree. We consider the case that ‘M’ is let infinite.

$$lim ( M \to ∞ ) {q}_{n} = lim ( M \to ∞ ) {( - {q}_{1} / M )}^{n} M ! / ( M - n ) ! n ! \\ = - {( - {q}_{1} )}^{n + 1} / n !$$

∵qₙ=(−q₁)ⁿ⁺¹/n!, q=1−exp(−q₁Λ), @q=1 (M18)

q={q₁, −q₁²/2, q₁³/6, −q₁⁴/24, q₁⁵/120, −q₁⁶/720, . . . } (M19)

‘q’ can be approximated by RFS of degree 5 with the precision of 1%. Thus ‘a’ is approximated by RFS of degree 5. It is considered common for degeneration of imaginary poles except for that ‘q₁’ is complex number.

Supposed the control period is long enough, the degree differential equation can be regarded as less than or equal ‘5’.

T is proper [symbol] M≦5 (M20)

The result agrees with our experience. But we continue considering the case of not oscillator. We try the single pole approximation.

1−q=Σ_{n∈[0.∞]}(−q₁Λ)ⁿ/n!=exp (−q₁Λ) (M21)

(1−q_{∞1}Λ)R=a(1−q₁Λ) exp (q₁Λ)C=a_{∞}C (M22)

a_{∞}≡a(1−q_{∞1}Λ) exp (q₁Λ)=a(1−U_{∞}) (M23)

U_{∞}≡1−(1−q_{∞1}Λ) exp (q₁Λ), g_{∞}≡q_{∞1}/q₁ (M24)

$$\begin{matrix}{U}_{\underline{∞}} = 1 - ( 1 - {q}_{{∞}^{1}} Λ ) {\underline{\sum }}_{n ∈ [ 0 , + ∞ ]} {( {q}_{1} Λ )}^{n} / n ! \\ = - {\underline{\sum }}_{n ∈ [ + ∞ ]} {( {q}_{1} Λ )}^{n} / n ! + {g}_{\underline{∞}} {\underline{\sum }}_{n ∈ [ 0 , + ∞ ]} {( {q}_{1} Λ )}^{n + 1} / n ! \\ = {\underline{\sum }}_{n ∈ [ + ∞ ]} {( {q}_{1} Λ )}^{n} / n ! + {g}_{\underline{∞}} {\underline{\sum }}_{n ∈ [ + ∞ ]} {n ( {q}_{1} Λ )}^{n} / n ! \\ = {\underline{\sum }}_{n ∈ [ + ∞ ]} ( {g}_{\underline{∞}} n - 1 ) {( {q}_{1} Λ )}^{n} / n !\end{matrix}$$

@U_{∞}=1 (M26)

We have get the following result under the condition ‘g_{∞}=1.25’, ‘q₁=0.8’ and ‘q₁=1’.

$${U}_{\underline{∞}} = \{ 0.2 , 0.47 , 0.235 , 0.068 , 0.014 , 0.002 , 0.000 , 0.000 , … \}$$

‘U_{∞}’ can be also approximated by RFS of degree 4 with precision of 2%. Therefore the degree of ‘a_{∞}’ is 9. This result is applicable to the case ‘M≧5’. ‘&b’ is considered the same as ‘&a’ when filter effect is negligible.

Supposed the system is not an oscillator, the system can be approximated by single pole representation, and both of ‘&a’ and ‘&b’ are ‘2M−1’ without filter effect when the period is proper.

T is proper, Not oscillator [symbol] M≦5, &q=1, &a=2M−1, &b=2M−1 (M28)

We call this equation N-eq. Of course, the degree of COF depends on the precision of approximation. The precision of the approximation of the above expression is selected so that the representation becomes simple. When many measurable disturbances are fed forward and when the degree of differential equation is higher than ‘2’, total terms of ‘q’, ‘a’ and ‘b’ becomes large, so that N-eq is not recommended. Corresponding D-eq has much less terms. The measurable disturbance can be one bit data or low precision data. In many cases ‘%b’ is taken 1 or 0. (FIG. 3)

In previous art, the range of ‘s’ and ‘D’ used is extended to ‘&qa’ periods after without deep investigation. We consider REFRE.

r=fc+gd (C01)

Since ‘f’ is not a finite sequence, ‘r’ cannot be usually a finite sequence even if ‘c’ is a finite sequence and ‘d’ is 0.

FT-settling doesn't result from FT-manipulating.

We consider COFRE next.

r=qr+ac+bd, ∵c={(1−q)r−bd}/a (C02)

We suppose the case ‘r’ is a finite sequence and ‘d’ is 0, both ‘(1−q)r−bd’ and ‘a’ are finite sequences. However the quotient cannot be a finite sequence usually, it is usually an infinite sequence.

FT-manipulating doesn't result from FT-settling.

If perfectly stable system is expected both of FT-settling and FT-manipulating namely FT-determining must be satisfied.

Thus we seek the solution, which satisfies the condition that each of ‘r’, ‘c’ and ‘d’ is a finite sequence.

Unless special condition exists, that the settling time is delayed by ‘D’ is undesirable. The following condition is added to the above condition.

‘D’ doesn't increase the settling time.

(1−q)r=ac+bd (C03)

&ac=&qr=&q+&r=&a+&c, &q+&r≧&b+&d (C04)

&r=&a+&c−&q, &d≦&a+&c−&b=&q+&r−&b (C05)

While all COV and COF in (C02) are finite sequences, both sides of (C02), whose order are higher than ‘&ac’, are ‘0’.

r_{n>&qa}=0, (qr)_{n>&qa}=(qr)_{n>&q+&r}=0

(ac)_{n>&qa}=(ac)_{n>&a+&c}=0, (bd)_{n>&qa}=0 (C06)

Therefor (C02) has ‘&ac’ equations in future part except trivial equations ‘0=0’. But additional one condition is needed for settling.

R_{&a}=R₀+r₁+r₂+ . . . +r_{&r}=S_{&a} (CO7)

While the unknowns are ‘r₁,r₂, . . . , r_{&r};c₀, c₁, . . . , c_{&c}’, the number of unknowns is ‘&r+&c+1’. Both numbers of the equations and unknowns must agree unless special conditions are added.

&r+&c+1=&a+&c+1=&q+&r+1 (C08)

&r=&a, &c=&q (C09)

&d≡&qa−&b (C10)

Thus even when the future data ‘s_{n>&a}’ or ‘d_{n>&d}’ are available, all must be neglected and regarded as ‘0’ under the condition of FT-determining. And the settling time becomes ‘&a’. But ‘R’ can be accidentally settled before the settling time.

S_{n>&a}=0C_{n>&q}=0, d_{n>&d}=0 (C11)

R_{n≧&a}=S_{&a}, C_{n≧&q}=C_{n≧&q}, D_{n≧&d}=D_{&d} (C12)

This solution satisfies the following expression unless new conditions are added such as new command ‘S_{n>&a}≠0’ or new disturbance ‘d_{n>&d}≠0’.

c=(r−qr−bd)/a (C13)

C=(R−qR−bD)/a (C14)

Namely the solution is strict and the result ‘C’ is the same in any period unless the condition is altered. But the solution of previous art is not strict. It doesn't satisfies the above expression even when new conditions, such as new command ‘S_{n>&qa}≠0’ or new disturbance ‘d_{n>&qa}≠0’, are not given as long as ‘S_{n>&a}≠0’ or ‘d_{n>&d}≠0’. The characteristics of (C13) and. (C14) is that variables in the right side is determined satisfying FT-determining. In what state is the system controlled if FT-determining is not satisfied? We have investigated this by simulation and real operation. The result is the following (FIG. 8). When ‘S’ is changed stepwise, obvious deviation with two sharp peaks is observed in the curve of not-FT-determining namely previous art (curve 1), but no such peak are observed in the curve of FT-determining (curve 2). Only delay caused by the limitation of ‘C’ and propagation speed is observed. But when ‘S’ is changed continuously along the polynomial of degree five, obvious difference is not observed. Therefore such extension may be allowable unless the command is not changed stepwise. On the other hand, even when ‘D’ is changed continuously along the polynomial of degree five, a slight difference is observed between them. And when ‘D’ is changed stepwise (FIG. 7), obvious deviation is observed in not-FT-determining curve (curve 1), but only slight deviation caused by the limitation of ‘C’, by the difference between ‘a’ and ‘b’, and by the propagation speed is observed in FT-determining curve (curve 2). Thus the condition of FT-determining improve the control precision clearly.

The first simultaneous equation to be solved is the following and its unknowns are ‘c₀, c₁, . . . , c_{&q};r₁, r₂, . . . , r_{&a}’

r₁+r₂+ . . . +r_{&a}=S_{&a}−R₀, rₘ=(qr+ac+bd)ₘm ∈[1, &qa] (C15)

Let's solve COFRE and find the formula of the solution. COV is classified as the following.

r=r^{o}+r^{K}+r^{U}, C=C^{O}+c^{K}+c^{U}, d=d^{O}+d^{K}

&r^{o}=−&q, @r^{K}=1−&q, &r^{K}=0, @r^{U}=1, &r^{U}=&a

&c^{o}=−&a, @c^{K}=1−&a, &c^{K}=−1, @C^{U}=0, &C^{U}=&q

&d^{o}=−&b, @d^{K}=1−&b, &d^{K}=&d=&qa−&b (C16)

R=R^{O}+R^{K}+R^{U}+S^{D}, C=C^{O}+C^{K}+C^{U}, D=D^{O}+D^{K},

S^{D}=S_{&a}Λ^{&a}Σ, C^{D}_{n≧&q}=C_{&q}, D^{K}_{n≧&d}=D_{&d}

&R^{O}=−&q, @R^{K}=1−&q, &R^{K}=0, @R^{U}=1, &R^{U}=&a−1, @R^{D}=&a

&C^{O}=−&a, @C^{K}=1−&a, &C^{K}=−1, @C^{U}=0

&D^{O}=−&b, @D^{K}=1−&b (C17)

‘R^{O}’, ‘C^{O}’, ‘D^{O}’, ‘r^{o}’, ‘c^{o}’ and ‘d^{o}’ are old data, which are not used for calculation of ‘c₀’ or ‘C₀’, ‘R^{K}’, C^{K}’, ‘D^{K}’, ‘r^{K}’, ‘C^{K}’ and ‘d^{K}’ are data, which are used as known quantities. ‘R^{u}’, ‘C^{u}’, ‘r^{u}’, and ‘c^{u}’ are data, which are used as unknown quantities. ‘D’ and ‘d’ have no data as unknowns. ‘S^{D}’ is the part of the command to be settled.

We define a sequence for convenience, sake.

p≡1−q, P≡Σp=Σ−Q (C18)

The equation in matrix form, where unknowns are arranged in the left side and knowns are arranged in the right side, is the following. (FIG. 2)

mx=e &qa≡&qa, i, j∈[&qa+1]

x≡(C₀, C₁, . . . , C_{&q}, r₁, r₂, . . . , r_{&a})^{T}

e≡k(S_{&a}−R₀)−qr^{K}−ac^{K}−bd^{K}

r^{K}≡(r₀, r₋₁, . . . , r_{-&q})^{T}, C^{K}≡(C₋₁, C₋₂, . . . , C_{1-&a})^{T},

d^{K}(d_{&d}, . . . , d₁, d₀, d₋₁, . . . , d_{1-&b})^{T} (C19)

m_{i∈[&qa], j∈[&q+1]}≡aᵢ₋ⱼ₊₁,

m _{i∈[&qa], j∈[&q+2, &qa+1]}≡−p_{i-j+&q+i},

m_{&qa+1, j∈[&q+1]}≡0, m_{&qa+1, j∈[&q+2, &qa+1]}≡1

k_{i∈[&qa]}≡0, k_{&qa+1}≡1,

q_{i∈[&qa], k∈[&q]≡q}ᵢ₊ₖ₋₁, q_{&qa+1, k∈[&q]}≡0,

a_{i∈[&qa], k∈[&a-1]}≡aᵢ₊ₖa_{&qa+1, k∈[&a-1]}≡0,

i∈[&qa], k∈[&b+&d]≡b_{i+k-&d-1}, b_{&qa +1, k∈[&b+&d]}≡0, (C20)

(Attention!P_{n<0}=p_{>&q}=a_{n<1}=a_{n>&a}=b_{n<1}=b_{n>&b}=0)

Using the first row of the inverse matrix of ‘m’, ‘c₀’ is represented as the following.

$$\begin{matrix}{c}_{0} = {\underline{\sum }}_{i ∈ [ \& q a + 1 ]} {m}_{1 , i}^{- 1} {e}_{i} \\ = {\underline{\sum }}_{i ∈ [ \& q a + 1 ]} {{m}_{1 , i}^{- 1} ( k ( {S}_{\& a} - {R}_{0} ) - q {r}^{\underline{K}} - a {c}^{\underline{K}} - b {d}^{\underline{K}} )}_{i}\end{matrix}$$

This formula is changed into the difference equation letting the coefficients of ‘S_{&a}, r_{—i}, c_{—i}, d_{—i}’ be ‘k₀, \overline{q}ᵢ, \overline{a}ᵢ, \overline{b}ᵢ’.

c=\overline{k}(Z^{&a}S^{D}−R^{K})+\overline{q}r^{K}+\overline{a}c^{K}+\overline{b}d^{K}

\overline{k}₀=Σ_{i∈[&qa+1]}m⁻¹_{1, i}kᵢ, \overline{q}ⱼ=Σ_{i∈[&qa+1]}m⁻¹_{1, i}q_{i, j},

\overline{a}ⱼ=Σ_{i∈[&qa+1]}m⁻¹_{1, i}a_{i, j,} \overline{b}_{&b-j}=Σ_{i∈[&qa+1]}m⁻¹_{1, i}b_{i, j} (C22)

@\overline{k}=&\overline{k}=0, @\overline{q}=0, &\overline{q}=&q−1, @\overline{a}=1, &\overline{a}=&a−1,

@\overline{b}=&b−1, &\overline{b}=−&d=&b−&a−&q (C23)

Each of ‘\overline{k}, \overline{q}, \overline{a}, \overline{b}’ is a finite sequence. Thus ‘c₀’ is directly calculated using raw data solving directly COFRE under the condition of FT-determining. Amended by noise compression and/or error distribution, C₀ is output. Of course, the amendment and/or ‘D’ can be omitted if desired.

c₀=k_{CRD}·c₀C₀=C₋₁+c₀ (A24)

We solve (C25) under the condition of FT-determining.

Rₘ=(qR+aC+bD)ₘm∈[&qa] (C25)

We must pay attention to the coefficients of ‘C_{&q}’ and ‘D_{&d}’ while ‘C_{n>&q}’ and ‘D_{n>&d}’ are represented by ‘C_{&q}’ and ‘D_{&d}’.

$$\begin{matrix}{R}_{m} = {\underline{\sum }}_{i} {q}_{m - i} {R}_{i} + {\underline{\sum }}_{i} {a}_{m - i} {C}_{i} + {\underline{\sum }}_{i} {b}_{m - i} {D}_{i} \\ = {\underline{\sum }}_{i} {q}_{i} {R}_{m - i} + {\underline{\sum }}_{i < \& q} {a}_{m - i} {C}_{i} + {\underline{\sum }}_{i ≧ \& q} {a}_{m - i} {C}_{i} + \\ {\underline{\sum }}_{i < \& d} {b}_{m - i} {D}_{i} + {\underline{\sum }}_{i ≧ \& d} {b}_{m - i} {D}_{i} \\ = {\underline{\sum }}_{i} {q}_{i} {R}_{m - i} + {\underline{\sum }}_{i < \& q} {a}_{m - i} {C}_{i} + {A}_{m - \& q} {C}_{\& q} + \\ {\underline{\sum }}_{i < \& d} {b}_{m - i} {D}_{i} + {B}_{m - \& d} {D}_{\& d}\end{matrix}$$

Let's check the terms after settled.

R_{n≧&qa}=S_{&a}, (qR)_{n≧&qa}=Σ_{i∈[&q]}qᵢRₙ₋ᵢ=S_{&aΣi}qᵢ=Q_{&q}S_{&a}

(aC)_{n≧&qa}=Σ_{i∈[&a]}aᵢCₙ₋ᵢ=C_{&qΣi}aᵢ=A_{&a}C_{&q}

(bD)_{n≧&qa}=Σ_{i∈[&b]}bᵢDₙ₋ᵢ=D_{&dΣi}bᵢ=B_{&b}D_{&d} (C27)

Equations represented by (C25) of the orders that are higher than or equal ‘&qa’ are all the same equation.

S_{&a}=Q_{&q}S_{&a}+A_{&a}C_{&q}+B_{&b}D_{&d} (C28)

C_{&q}={(1−Q_{&q})S_{&a}−B_{&b}D_{&d}}/A_{&a} (S29)

From (S29), the final constant value of ‘C’ is obtained. And additional condition such as (C07) is unnecessary because (S29) contains ‘S_{&a}’. We arrange unknowns in the left side and knowns in the right side in a matrix form. (FIG. 1)

MX=E, X≡(C₀, C₁, . . . , C_{&q}, R₁, R₂, . . . , R_{&a-1})^{T}

E≡KS_{&a}−QR^{K}−AC^{K}−BD^{K}, R^{K}≡(R₀, R₋₁, . . . , R_{1-&q})^{T},

C^{K}≡(C₋₁, C₋₂, . . . , C_{1-&a})^{T}, D^{K}≡(D_{1-&ab}, . . . , D₋₁, D₀, D₁, . . . , D_{&d})^{T} (C30)

M_{i∈[&qa], j∈[&q]}≡aᵢ₋ⱼ₊₁, M_{i∈[&qa], &q+1}≡Aᵢ₋ⱼ₊₁,

M_{i∈[&qa], j∈[&q+2, &qa]}≡−p_{i-j+&q+2}, K_{i∈[&qa]}≡P_{i-&a},

Q_{i∈[&qa], k∈[&q]}≡qᵢ₊ₖ₋₁A_{i∈[&qa], k∈[&a-1]}≡a_{k+j,}

B_{i∈[&qa], 1}≡B_{i-&d-1}, B_{j∈[&qa], k∈[2, &qa]}≡b_{i+k-&d-2} (C31)

(Attention!p_{n<0}=p_{>&q}=a_{n<1}=a_{n>&a}=b_{n<1}=b_{n>&b}=0

P_{n<0}=0, A_{n<1}=0, B_{n<1}=0)

Using the first row of the inverse matrix of ‘M’, ‘C₀’ is as the following.

C₀=Σ_{i∈[&qa]}M⁻¹_{1, i}Eᵢ=Σ_{i∈[&qa]}M⁻¹_{1, i}(KS_{&a}−QR^{K}−AC^{K}−BD^{K})ᵢ (C32)

This formula is changed into the difference equation letting the coefficients of ‘S_{&a}, R₋ᵢ, C₋ᵢ, D₋ᵢ’ be ‘\overline{K}₀, \overline{Q}ᵢ, \overline{A}ᵢ, \overline{B}ᵢ’. Each of ‘\overline{K}, \overline{Q}, \overline{A}and \overline{B}’ is a finite sequence.

C=\overline{K}Z^{&a}S^{D}+\overline{Q}R^{K}+\overline{A}C^{K}+\overline{B}D^{K} (C33)

\overline{K}₀=\overline{Σ}_{i∈[&qa]}M⁻¹_{1, i}Kᵢ, \overline{Q}ⱼ=Σ_{i∈[&qa]}M⁻¹_{1, i}Q_{i, j},

\overline{A}ⱼ=Σ_{i∈[&qa]}M⁻¹_{1, i}A_{i, j}, \overline{B}_{&b-j}=Σ_{i∈[&qa]}M⁻¹_{1, i}B_{i, j}

@\overline{K}=&\overline{K}=0, @\overline{Q}=0, &\overline{Q}=&q−1, @\overline{A}=1, &\overline{A}=&a−1,

@\overline{B}=&b−1, &\overline{B}=−&d=&b−&a−&q (C34)

Thus ‘C₀’ is directly calculated using raw data solving directly COFRE under the condition of FT-determining. C₀ is output amended by noise compression and/or error distribution.

c₀=k_{CRD}·(C₀−C₋₁)→C₀=C₋₁+C₀ (C35)

Of course, the amendment and/or ‘D’ can be omitted if desired.

(C22) and (C33) can be deformed multiplied by ‘Σ’ or ‘Δ’.

C=\overline{k}(Z^{&a}σ^{D}−ρ^{K}+\overline{q}R^{K}+\overline{a}C^{K}+\overline{b}D^{K}σ≡ΣS, ρ≡ΣR

C=\overline{K}Z^{&a}S^{D}+\overline{Q}r^{K}+\overline{A}C^{K}+\overline{B}d^{K} (C37)

(C36) can be applied for position control when (C33) is applied for speed control for example. Similarly (C37) can be applied for speed control when (C22) is applied for position control. Thus NACS is applicable to complex system, which have plural commands. Position control, where speed is limited, is an example.

C=ΛC+\overline{k}(Z^{&a}S^{D}−R^{K})+\overline{q}r^{K}+\overline{a}c^{K}+\overline{b}d^{K}

C=\overline{k}(Z^{&a}σ^{D}−ρ^{K})+\overline{q}R^{K}+\overline{a}C^{K}+\overline{b}D^{K}

C=\overline{K}Z^{&a}S^{D}+\overline{Q}R^{K}+\overline{A}C^{K}+\overline{B}D^{K}

C=ΛC+\overline{K}Z^{&a}S^{D}+\overline{Q}r^{K}+\overline{A}C^{K}+\overline{B}d^{K} (C38)

We call ‘\overline{k}, \overline{q}, \overline{a}, \overline{b};\overline{K}, \overline{Q}, \overline{A}, \overline{B}’ MAF (Manipulation function), the above four equations MAFRE (MAF representation). When the system or subsystem is not complex between difference and sum, the last form of (C38) is recommended. The form has integral effect so that nonlinearlity or deviation of original point of ‘R’ or ‘C’ is automatically corrected. Both ‘\overline{K}’ and ‘\overline{k}’ correspond to control gain. For comparison's sake between PID and NACS, let's calculate MAF in the case of Ziegler-Nichols model when ‘T’ is ‘KT_{L’.}

&q=1, &a=2, &b=3; q₁=exp(−s₀KT_{L})≠1, q_{n≦0}=q_{n>1}=0

a₁=0, a₂=KT_{L}, a_{n≦0}=a_{n>2}=0, ;b_{n≦0}=b_{n>3 2}=0 (C39)

&a+&q+1=4, x≡(c₀, c₁, r₁, r₂)^{T}

m_{1, 1}=a₁, m_{1, 2}=a₀=0, m_{1, 3}=p₀=−1, m_{1, 4}=p₋₁=0,

m_{2, 1}=a₂, m_{2, 2}=a₁, m_{2, 3}=−p₁=q₁, m_{2, 4}=p₀=−1,

m_{3, 1}=a₃=0, m_{3, 2}=a₂, m_{3, 3}=q₂=0, m_{3, 4}=q₁,

m_{4, 1}=0, m_{4, 2}=0, m_{4, 3}=1, m_{4, 4}=1,

m⁻¹_{1, 1}=(a₂+q₁A₂)/A₂(a₂+q₁a₁), m⁻¹_{1, 2}=a₂/A₂(a₂+q₁a₁),

m⁻¹_{1, 3}=−a₁/A₂(a₂+q₁a₁), m⁻¹_{1, 4}=1/(a₂+q₁a₁) (C40)

We calculate MAF by (C23).

\overline{k}₀=m⁻¹_{1, 4}=1/(a₂+q₁a₁)=1/KTL,

\overline{q}₀=−q₁m₋₁_{1, 1}=−q₁(a₂+q₁A₂)/A₂(a₂+q₁a₁)=−q₁(1+q₁)/KT_{L},

\overline{a}₁=−a₂m⁻¹_{1, 1}=−a₂(a₂+q₁A₂)/A₂(a₂+q₁a₁)=−(1+q₁),

\overline{b}₀={(1+q₁)b₁+b₂}/KT_{L}, \overline{b}₁={(1+q₁)b₂+b₃}/KT_{L},

\overline{b}₂=(1+q₁)b₃/KT_{L},

c₀=\overline{k}₀(S₂−R₀)+\overline{q}₀r₀+\overline{a}₁c₋₁+\overline{b}₀d₀+\overline{b}₁d₋₁+\overline{b}₂d₋₂ (C41)

Instead of using matrix, we solve simultaneous equation.

R₁=q₁R₀+a₁C₀+a₂C₋₁+b₁D₀+b₂D₋₁+b₃D₋₂

R₂=q₁R₁+a₁C₁+a₂C₀+b₁D₁+b₂D₀+b₃D₋₁

R₃=q₁R₂+a₁C₂+a₂C₁+b₁D₂+b₂D₁+b₃D₀ (C42)

We consider (C28) and solve COFRE.

R₁=q₁R₀+a₁C₀+a₂C₋₁+b₁D₀+b₂D₋₁+b₃D₋₂

S₂=q₁R₁+a₁C₁+a₂C₀+b₁D₀+b₂D₀+b₃D₋₁

S₂=q₁S₂+a₁C₁+a₂C₁+b₁D₀+b₂D₀+b₃D₀ (C43)

R₁=q₁R₀+a₁C₀+a₂C₋₁+b₁D₀+b₂D₋₁+b₃D₋₂

a₂C₀=S₂−q₁R₁−a₁C₁−B₂D₀−b₃D₋₁

C₁={(1−q₁)S₂−B₃D₀}/A₂ (C44)

a₂C₀=S₂−q₁(q₁R₀+a₁C₀+a₂C₋₁+b₁D₀+b₂D₋₁+b₃D₋₂)

a₁{(1−q₁)S₂−B₃D₀}/A₂−B₂D₀−b₃D₋₁ (C45)

(a₂+q₁a₁)C₀={A₂−a₁(1−q₁)}S₂/A₂−q¹²R₀−q₁a₂C₋₁

−(q₁b₁−a₁B₃/A₂+B₂)D₀−[q₁b₂+b₃]D₋₁−q₁b₃D₋₂ (C46)

C₀=S₂/KT_{L}−q₁²R₀/KT_{L}−q₁C₋₁

−(q₁b₁+B₂)D₀/KT_{L}−(q₁b₂+b₃)D₋₁−q₁b₃D₋₂ (C47)

\overline{K}₀=1/KT_{L}, \overline{Q}₀=−q₁²/KT_{L}, \overline{A}₁=−q₁,

\overline{B}₀=−(q₁b₁+b₁+b₂)/KT_{L}, \overline{B}₁=−(q₁b₂+b₃), \overline{B}₂=−q₁b₃

C₀=\overline{K}₀S₂+\overline{Q}₀R₀+\overline{A}₁C₋₁+\overline{B}₀D₀+\overline{B}₁D₋₁+\overline{B}₂D₋₂ (C48)

By the way, PID constants by Ziegler-Nichols' method are the following.

C=kₚ(E+k_{I}∫₀^{t}Edt+k_{D}(dE/dt))E≡S−R

P−control k_{P}=1/KT_{L}, k_{I}=k_{D}=0

PI−control k_{P}=0.9/KT_{L}, k_{I}=1/3.3T_{L}≠0.3/T_{L}, k_{D}=0

PID-control k_{P}=1.2/KT_{L}, k_{I}=0.5/T_{L}, k_{D}=0.5T_{L} (C49)

Sosuke Iwai, ‘Seigyo kogaku kisoron’ (The Elemental Control Technology) Inc. Shokodo pp123-124

‘Seigyo kogaku handobukku’ (Handbook for control technology) Asakura Shoten p186

We find control gains ‘\overline{k}’, ‘\overline{K}’, and ‘k_{P}’ are nearly the same. Therefore both noise levels are similar when PID has no filter and NACS is without noise compression. Control gains are inversely proportional to ‘KT_{L}’ that is control period of NACS.

When we use NACS, we must determine the control period and the degree of COF. We explain using FIG. 9. When the operation is the first time, the system enters into test phase. In test phase, noise level ‘N0I’, control period ‘T’, the degree of COF, and COF are determined for each subsystem. ‘N0I’ is measured first. The manipulated variable is kept the fixed safe value ‘C^{SAF}’. The value ‘C^{SAF}’ is the safety value that the manipulated value is kept for safety, which is set zero and which corresponds to power off value in many cases. ‘C’ is kept constant. When ‘D’ can be controlled, ‘D’ is kept constant. Then ‘R’ becomes constant within noise level. The control period is set the minimum period ‘T^{MIN}’ in order to make ‘d’ the smallest even when ‘D’ cannot be kept constant. The system uses the same AD converter that is set the same converting speeds independent from the control period, in many cases. Noise level becomes then almost the same independent from the control period. The control period can be other proper value if this condition is not satisfied. Therefore ‘N0I’ is measured as root mean square sum of ‘r’ and ‘DGT’. This measurement is carried out the fixed times ‘N^{MAX}’. However this value ‘N0I’ is not amplified by control gain. The value becomes from three times to ten times even under the noise compression in settled state by experience. Therefore ‘N0I’ is multiplied by ‘k^{AMP}’, which is set about ten. Of course, ‘k^{AMP}’ can be altered matching the case.

k^{AMP}≠10 (101)

N0I=k^{AMP}·\sqrt{0}(Σ_{n∈N}^{MAX}(rₙ²+DGT²)/N^{MAX}) (I02)

p^{NS}=1/N^{MAX} (I03)

It is undesirable that settling time is in excessively near future. And the control gain is inversely proportional to control period in many cases, as mentioned above. We consider the start terms of ‘a’ and ‘b’ which are obtained by conversion formula.

a_{@a}=f_{@a}, b_{@b}=g_{@b}←a=(1−q)f, b=(1−q)g (I04)

Both of ‘f’ and ‘g’ are impulse response functions integrated during ‘T’. Therefor COF and REF become small when ‘T’ is short. And these become rapidly very small when ‘T’ is shorter than rising part of the response functions. Controlled function ‘q’ represents the damping rate of impulse response functions. Therefore the precision depends on the precision of ‘f’ namely ‘a’. Thus COF becomes difficult to be identified in the fixed precision when ‘T’ is excessively short. These facts suggest that there is a proper value for the control period. And if man use the control period shorter than the proper value man cannot get any good result. The control period, therefore, must be determined so that COF can be identified with the fixed precision. Good COF makes the system stable by FT-determining. And good COV, which is calculated by good COF, reduces noise because needless reactions aren't caused. If the control variable is expected to be settled within the precision 1% of the initial deviation in the settling time, the precision ‘k^{ACC}’ is set ‘100’. And if 0.1% is expected, ‘k^{ACC}’ is set ‘1000’. When each ‘|rₙ|’ of tuning data is greater than ‘k^{ACC}·N0’, COF can be identified in the precision. It must be paid attention that the precision of digital data can be never improved by statistical treatment when noise is small compared with ‘DGT’. Therefore the condition ‘k^{ACC}·N0’ can be reduced only when noise is sufficiently large. However, When ‘k^{ACC}·N0I’ is greater than full scale of ‘R’, it is impossible for |rₙ| to exceed it. And it is not a normal control that ‘S’ is frequently changed from the minimum value to the maximum value or its reverse. The limit value of ‘k^{ACC}·N0I’ is usually determined about 10% of full scale considering automatic tuning.

k^{LIM}≠0.1 (105)

k^{RES}=k^{ACC}·N0I, s^{HL}≡k^{LIM}·(R^{MAX}−R^{MIN})

k^{RES}>S^{HL} [symbol] k^{RES}=S^{HL} (I06)

Thus control period is determined so that the response namely ‘|rₙ|’ becomes greater than ‘k^{RES}’ in ‘T’. Control period is used as a timer. Control period is set two times minimum value ‘2·T^{MIN}’ and ‘C’ is kept ‘C^{RES}’. The reason of ‘2·T^{MIN}’ is that the system with dead time can be naturally adapted. The value ‘C^{RES}’ is the maximum value ‘C^{MAX}’ in many cases. But when ‘C^{RES}’ is the same as ‘C^{MAX}’, ‘C^{RES}’ is set the minimum value ‘C^{MIN}’. And when outputting ‘C^{MAX}’ in response test is undesirable, ‘C^{RES}’ is set the other value such as ‘10.3·C^{MAX}’. The controlled variable ‘R₀’ is reserved as ‘R_{—}0’. While ‘C’ is kept constant, we wait until the nth period when the condition ‘|R₀−R_{—}0|≧2·k_{ACC}·N0I’ is satisfied. If it is not satisfied within the fixed periods, the system is considered not connected. Then safety program is let run. The alarm is output and the system is stopped for example. When it satisfies, the manipulated variable is set ‘C^{SAF}’, control period ‘T’ is set ‘n·T^{MIN}’. ‘R’ rises in the first or the second period by the control period. This method is called optimisation of period. The control period determined by this method becomes some time more than ten times of the period of PID. It reduces noisiness and gives room for man machine interface. The degrees of COF can be estimated by the corresponding differential equation. And ‘&a’ or ‘&b’ is increased by the degrees of filters such as various lag, dead time, statistics smoothing, and degree of continuity. If ‘M’ the degree of the corresponding equations cannot be considered, its maximum value can be regarded as ‘5’. If single pole representation is preferred, the maximum values of both ‘&a’ and ‘&b’ without filter effect are set ‘2M−1’. And if the degrees of effective fitters cannot be considered, these are regarded as ‘1’. Each maximum value of ‘&a’ and ‘&b’ is assumed each sum. Values ‘&q’, ‘&a’, and ‘&b’ are finally determined by response test if the base of determination is fragile. Since each data set for tuning includes ‘c_{-&a}’ and ‘d_{—&b}’, we must wait the greater time between ‘&b+1’ and ‘&a+1’ periods. One period is for taking difference. ‘C’ is then set ‘C^{RES}’ during one period and is returned to ‘C^{SAF}’ in the next period and kept constant. The period, when ‘C’ is set ‘C^{RES}’, is assumed the Nth period. And we wait ‘&qa+1’ periods after then. If the measurable disturbance is controllable then ‘D’ is changed in the (N+&qa)th period. And ‘D’ is returned to the previous value in (N+&qa+1)th period and is kept constant. When the measurable disturbance changed after the nth period, the waiting periods are increased by ‘&q+&b’ periods. These tuning sets ‘x_{n∈[N+I, N+&qa or n+&qab]}, yₙ’ are used for the identification of COF. A little more data after the above periods can be used for tuning since the system is not controlled, ‘R’ is not settled in ‘&a’ periods.

xₙ≡(rₙ₋₁, . . . , r_{n-&q};cₙ₋, . . . , c_{n-&a};dₙ₋₁, . . . , d_{n-&b});yₙ=rₙ (I07)

When the data for ‘b’ is not obtained, we wait until the data for ‘b’ is completed. Thereafter COF is identified by the regression method and other parameters derived from COF such as MAF are calculated. The observation equation for regression is COFRE.

rₙ=q₁rₙ₋₁+ . . . +q_{&q}r_{n-&q}+a₁cₙ₋₁+ . . . +a_{&a}c_{n-&a}

+b₁dₙ₋₁+. . . +b_{&b}d_{n-&b} (108)

The identified COF is checked its degree. When the maximum absolute values of COF are ‘q_{#q}, a_{#a}, and b_{#b}’, these are called the peak terms. We let one of these be ‘u_{#u}’. If ‘|uₙ/u_{#u}<2/k^{ACC}’, ‘uₙ’ is regarded as zero and omitted. Even when the degree exceeds the proper value, the system can be controlled well. Considering calculation error/rounding factor ‘2’ is set. But when the degree is lower than the proper value, the system cannot be controlled well. Each of the maximum absolute values of ‘f’ and ‘g’ is let ‘f_{#f}’, and ‘g_{#g}’. We have found by experience that the degree of COF becomes lower than the proper value in the case that ‘#f>&a’ or ‘#g>&b’. These cases accord with ‘excessively near future’. Then, control period must be increased or the degree of COF must be increased. Thus COF and its degree is identified. The concept of degree systemisation contains this method.

Parameters derived from COF such as MAF are calculated and these and COF are reserved in nonvolatile memory. When the system is identified beforehand, test phase can be omitted. This procedure is carried out for each subsystem.

Then system enters into normal phase shown in form the 17th to the 23rd frame of FIG. 9. We wait ‘Max(&a,&b)+1’ periods for collecting initial data for control. Waiting count ‘N^{CNT}’ is set the value and count down each period. COF can change during the operation. The quantity of ink decreases in printer control system for example. Therefore the identification during the operation namely automatic tuning is necessary if precise control is expected. But NACS is very precise and fast control method, the data for tuning are strictly limited in short time after the special events. The special events in normal phase are the following three.

1. Command event: The command is changed larger than the value, by which COF can be identified above the fixed precision. It is judged that the event has happened when ‘|s_{&a}|’ becomes greater than the command threshold ‘s^{TH}’.

|s_{&a}|>s^{TH} [symbol] Command event (105)

2. Liberation event: The manipulated variable is not limited when it was limited in the last period and the error between the command and the controlled variable is larger than the value, which causes data sets, by which COF can be identified above the fixed precision. It is judged that the event has happened when ‘|S_{&a}−R₀|>s^{Th} and (C₋₁=C^{MIN} or C₋₁=C^{MAX}) and C₀≠C₋₁’. ‘C^{MIN}’ is the low limit value and ‘C^{MAX}’ is the high limit value.

|S_{&a}−R₀|>s^{TH}, (C₋₁=C^{MIN} or C₋₁=C^{MAX}), C₀≠C₋₁ [symbol] Liberation event (106)

3. FF event: The measurable disturbance to be fed forward is changed larger than the value, by which COF can be identified above the fixed precision. It is judged that the event has happened when ‘|d₀|’ becomes greater than the FF threshold ‘d^{TH}’.

|d₀|>d^{TH} [symbol] FF event (107)

Since control error ‘E=S_{&a}−R₀’ is dissolved in ‘&a’, periods, changing per period is ‘E/&a’. Therefore ‘s^{TH}’ must be ‘&a·k_{ACC}·N0I’. And ‘s^{TH}’ must be less than the fixed portion of full scale.

s^{TH}≡&a·k_{ACC}·N0I, if (s^{TH}>s^{HL}) s^{TH}=s^{HL} (108)

The measurable disturbance ‘d₀’ cause ‘R’ changing ‘B_{&b}·d₀’ during ‘&b’ periods if system is not under control such as in test phase. Therefore ‘d^{TH}’ becomes the following.

d^{TH}≡&b·s^{TH}/B_{&b}, d^{HL}≡k^{LIM}·(D^{MAX}−D^{MIN}), if(d^{TH}>d^{HL}) d^{TH}=d^{HL} (109)

The data sets from the next period of events to the ‘&qa’ periods after are used for the tuning. In the 21st frame of FIG. 9 ‘F^{EVT}’ is used and it is set when event happens. ‘0^{EVT}’ is a copy of ‘F^{EVT}’ of the last period. The first bit of ‘F^{EVT}’ is command event flag, the second bit is liberation flag, and the third bit is FF flag. And tuning counter ‘N^{TUN}’ is also used, it is set ‘&qa’ when ‘0^{EVT}’ is set, and it is decreased by one per collection of tuning data.

N^{TUN}=&qa=&q=&a (109)

When new tuning event happens before tuning counter becomes zero, it is set ‘&qa’ again. While it is not zero, tuning data are added to the tuning set in each period. When it becomes zero, the tuned COF is reserved preparing for the case old COF is requested. If COV of all subsystems can be observed in each subsystem, COF of all subsystems are identified in each system unless COF is common for all subsystems. Events are matched to each subsystem and checked. This time ‘type’ is ‘0’.

White noise is expected to obey normal distribution and almost never exceeds the five times standard deviation ‘5σ’. But the ‘N0I’ is amplified ‘1/k_{Res}’ when ‘R’ is not settled.

E₀=S_{&a}−R₀ (A18)

k_{Com}=k_{Res}+(1−k_{Res})E₀²/(₀²+k_{Dis}²N0I²) (A19)

C₀=k_{Com}·C₀C₀=C₋₁+c₀ (A20)

The standard deviation for this case is estimated by ‘ER’, which is obtained by the identification of COF.

COF=M_{X}−Y_{X} ER²=S_{Y}−k_{T}Y_{X} (A14)

ER²˜Σ_{nεN}E₋ₙ²/N^{ID} Eₙ=Rₙ−(qR+aC+bD)ₙ

σ²Σ_{nεN}E₋ₙ²/(N^{ID}−M^{ID}) M^{ID}≡&qab (A15)

‘ER’ is however not accurate unless the number of data sets ‘N^{ID}’ is large enough. ‘ER’ is then estimated by ‘N0I/k_{Res}’.

N^{ID}<N^{MAX} [symbol] ER=N0I/k_{Res} (I10)

Destroyer event is defined that the estimation gap ‘h₀’ exceeds the noise threshold ‘h^{TH}’. It is judged that large not-measurable disturbance, which is not fed forward, happens when destroyer event is detected in normal phase. The coefficient ‘k_{Dis}’ is taken more than ‘5’ because events more than five times the standard deviation seldom happen.

h₀=|r₀−q₁r₋₁− . . . −q_{&q}r_{-&q}−a₁c₋₁− . . . −a_{&a}c_{-&a}−b₁d₋₁− . . . −b_{&b}d_{-&b}| (A15)

h₀≧h^{TH}, h^{TH}≡k^{ER}·ER, k^{ER}≠5˜10 [symbol] destroyer event (I11)

When destroyer event is detected, tuning is stopped. ‘DEST’ is destroyer event flag in 22nd frame of FIG. 9. When destroyer happened, old tuning set is substituted for the tuning set, which is identified then. It is represented by ‘Load N^{SUB}’. Tuning is restarted after the confirmation that destroyer event doesn't happen so frequently. When destroyer event is detected repeatedly, the safety program runs. The alarm is output and the system is stopped for example. The special signal can be used for the confirmation. The fixed time interval can be also used for the confirmation. Such safety program is of course optional. Thus the system can evade the unstability caused by not-measurable disturbance. Even if the control is continued, the system doesn't fall into unstability after the disturbance is removed because COF is not identified then.

COF can lapse from old value or be changed during the interruption. An ink cartridge can be exchanged in printer control system for example. Therefore the system or subsystem must be checked after interruption. Restart of control, therefore, sets the system in fast phase. It is shown in FIG. 9 from the 16th frame to the 23rd frame. Fast phase can be started also when subsystem is changed. It is shown in the 20th frame of FIG. 9. When signal of subsystem exchange is given, branch (case) is determined by the type of the system (type), ‘F^{SUB}’ and manual input (K). ‘F^{SUB}’ is the flag whether COF of new subsystem has been checked in fast phase. When ‘fast tuning’ is manually requested, all of ‘F^{SUB}’ are reset.

case=φ(type, F^{SUB}, K) (I12)

If both of COF and COV must be exchanged when subsystem is changed then if COF has not been checked by fast tuning and ‘case’ is set ‘1’, else ‘case’ is set ‘2’. When ‘case’ is ‘1’ the system enters into fast phase, and when ‘case’ is ‘2’ only waiting is carried out to collect control data during ‘&qa+1’ periods like the start of normal phase. If COV of all subsystems can be observed in each subsystem, then ‘case’ is set ‘0’. COV, COF, MAF, ‘N0I’, ‘ER’ and tuning set are exchanged when subsystem is exchanged except for common values among subsystems. If COV of all subsystems are measured and COF of all subsystems are identified in the same time then the subsystems are exchanged without waiting periods. When fast phase starts, a spare tuning set ‘(M_{X}, Y_{X}, S_{Y}, N^{ID})^{SP}=(M^{SP}, Y^{SP}, S^{SP}, N^{SP})’ is prepared.

N^{SP}=0, M^{SP}ᵢ, ⱼ=0,Y^{SP}ⱼ=0, S^{SP}=0, i, jε[&qab] (I12)

And ‘C’ is kept ‘C^{SAF}’ during the first ‘MAX(&a, &b)+1’ periods in order to collect data for control. Thereafter the system is controlled as if in normal phase except for the followings. When the system is largely changed, the system may fall into oscillating state or ‘C’ is driven to the limit value. Therefore, adding to three events of normal phase, the following two events also start tuning in fast phase.

\mathring{4} Oscillation event: When ‘a’ is excessively different from the true value, the system falls into the state that the estimation gap ‘h₀’ exceeds the command threshold ‘s^{TH}’ excited by noise. And the control error is large enough for tuning above the precision and the manipulated variable is not limited. Then it is judged that the event has happened. The system often oscillates in the case absolute values of ‘aₙ’ are excessively small.

h₀≧h^{TH}, |S_{&a}−R₀|>s^{TH}, c₀≠0 [symbol] Oscillation event (I13)

\mathring{5} Saturation event: When ‘a’ has the inverse sign of the true value, the system falls into the state that ‘C₋₁’ is limited and the state is fixed. Then it is supposed that the event has happened and ‘C_{n≧0}’ is set ‘−C₋₁’ in one period and its response is checked. If ‘h₀’ exceeds ‘h^{TH}’ in this response the event is true. ‘F^{SAT}’ is the flag whether any event has happened in fast phase. This event is unnecessary to be checked if any event for tuning has happened.

(C₋₁=C^{MIN} or C₋₁=C^{MAX}), c₀=0, F^{SAT}=0 [symbol] Saturation event, C₀=−C₋₁ (I14)

The above two events don't happen when COF is correct or when the absolute values of ‘aₙ’ are larger than the true value. Then one of command event, FF event, and liberation event start tuning. The data sets from the next period of the event to the ‘&qa’ periods after are used for the tuning in fast phase, too. Tuning counter ‘N^{TUN}’ is also set ‘&qa’ when each event happens and is decreased by one then one tuning data ‘xₙ, yₙ’ are added to the tuning set.

N^{TUN}=&qa (I15)

When new tuning event happens before tuning counter becomes zero, tuning counter is set ‘&qa’, again. When tuning counter becomes zero, the tuned COF is reserved preparing when old COF is requested. The different points from normal phase are the following.

A) Additional two events mentioned above.

B) Tuning is continued even when destroyer event is detected. Destroyer event in fast phase is considered that COF is not correct.

C) When tuning counter becomes zero for the first time, if destroyer event has been detected, spare set is substituted for the tuning set. If spare tuning matrix is not regular because the data for ‘b’ are not yet completed, tuning set is supplemented data for ‘b’ for the moment. The value ‘DGT^{D}’ is one bit of ‘D’. But if the resolution of ‘D’ is smaller than 7 bits then ‘DGT^{D}’ is set ‘0.01’ times full scale of ‘D’.

M_{X}_{ᵢ}, ᵢ←M_{X}_{ᵢ}, ᵢ+(DGT^{D})², Y_{X}_{ᵢ}←Y_{X}_{ᵢ}+b_{i-&qa}·DGT^{D},

S_{Y}←S_{Y}+Σᵢ(b_{i-&qa})²iε[&qa+1, &qab] (I16)

D) If destroyer event has been detected then the system enters into normal phase after the data for ‘b’ are completed.

E) If destroyer event has not been detected when tuning counter becomes zero then the system enters into normal as it is.

Man who sets excessively short control period appeals that the interval from the command change to the settled time is important. Settling time is very short in NACS control. The delay from the command change to the beginning of the next control period can be cut by the following art called command breaking. If the command is changed at 100·t% of the period then COV is exchanged with time weighted average values as the following and differences are calculated using the modified new values. And new period is let start (FIG. 10) at once on the road of the period.

R←tΛR+(1−t)R, C←tΛC+(1−t)C, D←tΛD+(1−t)D (I17)

r=ΔR, c=ΔC, d=ΔD (I18)

This art decreases the delay almost perfectly.

Thus NACS is applicable to the complex system. The system is very stable even if strong disturbance is given. And the system can be automatically constituted. Namely the control period is determined by the precision of COF, degree of COF is determined by the degree systemisation, and COF is identified in three phases. And the manipulated variable is calculated solving COFRE under the condition of FT-determining. The formula of the solution giving manipulated variable is a linear form of raw COV called MAFRE. The subsystems can be easily and smoothly exchanged quickly.

### BRIEF EXPLANATION OF THE DRAWINGS

Explanation of common symbols

R controlled variable

C manipulated variable

D measurable disturbance

S command

r difference of R

c difference of C

d difference of D

s difference of S

q controlled function

a manipulated function

b FF function

t time

&q degree of q

&a degree of a

&b degree of d

&qa=&q+&a settling time

&qab=&q+&a+&b determination time

&d=&q+&a−&b end order to be used

^{K} known part of data

^{U} unknown part of data

^{O} old part not used

^{D} settled part of command

^{T} transpose

T the control period

FIG. 1 is the matrix form to calculate out the manipulated variable in the case COFRE is represented by ‘r=qr+ac+bd’. The last row represents ‘r₁+r₂+ . . . +r_{&a}=S_{&a}−R₀’. The unknown vector is ‘(c₀, c₁, . . . ,c_{&q}, r₁, r₂, . . . , r_{&a})^{T}’ in the left side. Each. term in the right side except for the last row is ‘0·(S_{&a}−R₀)’, ‘qr^{K}’, ‘ac^{K}’, and ‘bd^{K}’ except the last line. The super script ‘^{K}’ means known part of the data.

FIG. 2 is the matrix form to calculate out the manipulated variable in the case COFRE is represented by ‘R=qR+aC+bD’. The unknown vector is ‘(C₀, C₁, . . . , C_{&q}, R₁, R₂, . . . , R_{&a})^{T}’ in the left side. Each term in the right side is ‘(1−q)S^{D}’, ‘qR^{K}’, ‘aC^{K}’, and ‘bD^{K}’.

FIG. 3 shows the derivation of equations in the previous applications and this application. This chart is for help to distinguish notation of the equations.

FIG. 4 shows the electric circuit for explanation Minimal-Time Control and FT-settling.

Explanation of symbols

1 Resister

2 Capacitor/Condenser

3 Voltage source

4 Switcher

FIG. 5 shows how the controlled variable is settled by FT-settling in the both cases analogue control system and digital control system. ‘S’ is the command, ‘R’ is the controlled variable, ‘C’ is the manipulated variable, and ‘T’ is the control period.

Explanation of Symbols

5. Manipulated variable of analogue system

6. Manipulated variable of digital system

7. Controlled variable of analogue system

8. Controlled variable of digital system

FIG. 6 shows the types of impulse response functions, which can be applicable to Minimal-Time Control, 0ACS, and NACS. The system of all types of impulse response function can be controlled by NACS and settled in FT-settling.

Explanation of Symbols

9. Impulse response function that can be controlled by all of MTC, 0ACS and NACS. This curve is an exponential curve.

10. Impulse response function that can be controlled by 0ACS and NACS.

11. Impulse response function that can be controlled only by NACS.

12. Dead time.

FIG. 7 shows how the controlled variable deviates from the command when the measurable disturbance is changed step wise in the cases of not fed forward, not-FT-determining namely the previous art, and FT-determining. By FT-determining the deviation can be suppressed ideally. But not-FT-determining cannot suppress the deviation sufficiently.

Explanation of Symbols

1. Controlled variable when the system is controlled by NACS of the previous art, namely under the condition of not FT-determining when the measurable disturbance is changed stepwise.

2. Controlled variable when the system is controlled by the art of the invention, namely under the condition of FT-determining when the measurable disturbance is changed stepwise.

3. Controlled variable when the system is controlled by NACS without feed forward of the measurable disturbance when the measurable disturbance is changed stepwise.

FIG. 8 shows how the controlled variable deviates from the command when the command is changed in the cases of not-FT-determining namely the previous art, and FT-determining. By FT-determining the deviation can be suppressed ideally. But not-FT-determining cannot suppress the deviation sufficiently.

Explanation of Symbols

1. Controlled variable when the system is controlled by NACS of the previous art, namely under the condition of not FT-determining when the command (S) is changed.

2. Controlled variable when the system is controlled by the art of the invention, namely under the condition of FT-determining when the command (S) is changed.

FIG. 9 is the flow chart of the invention.

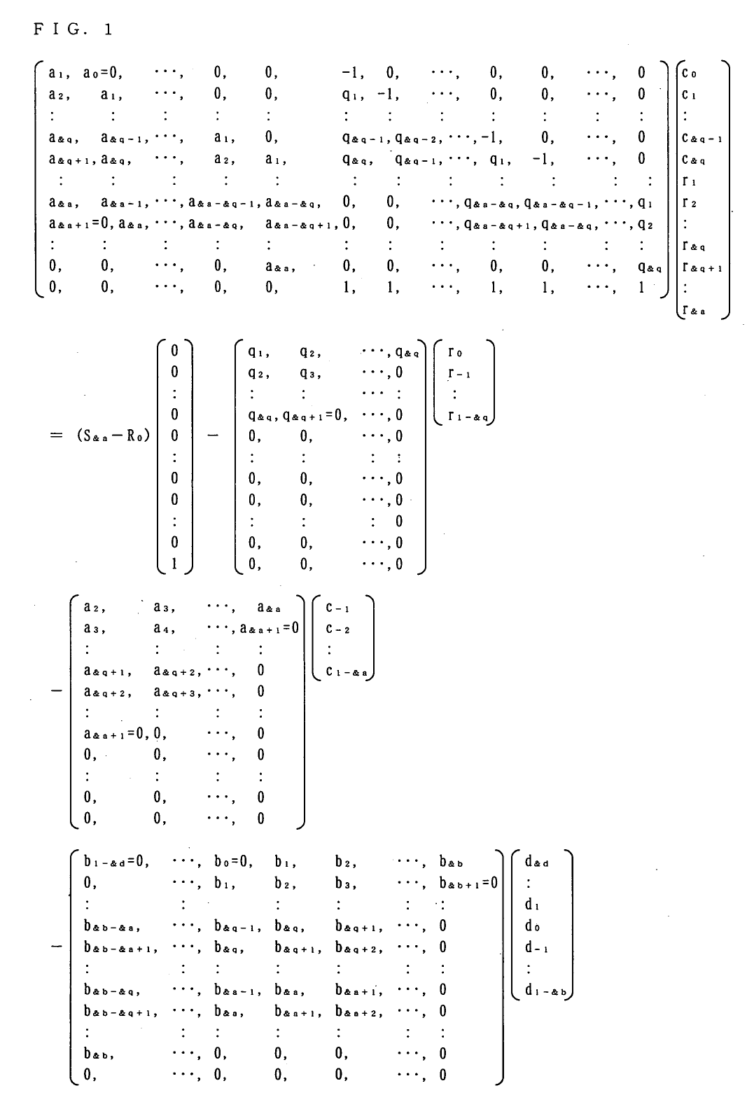

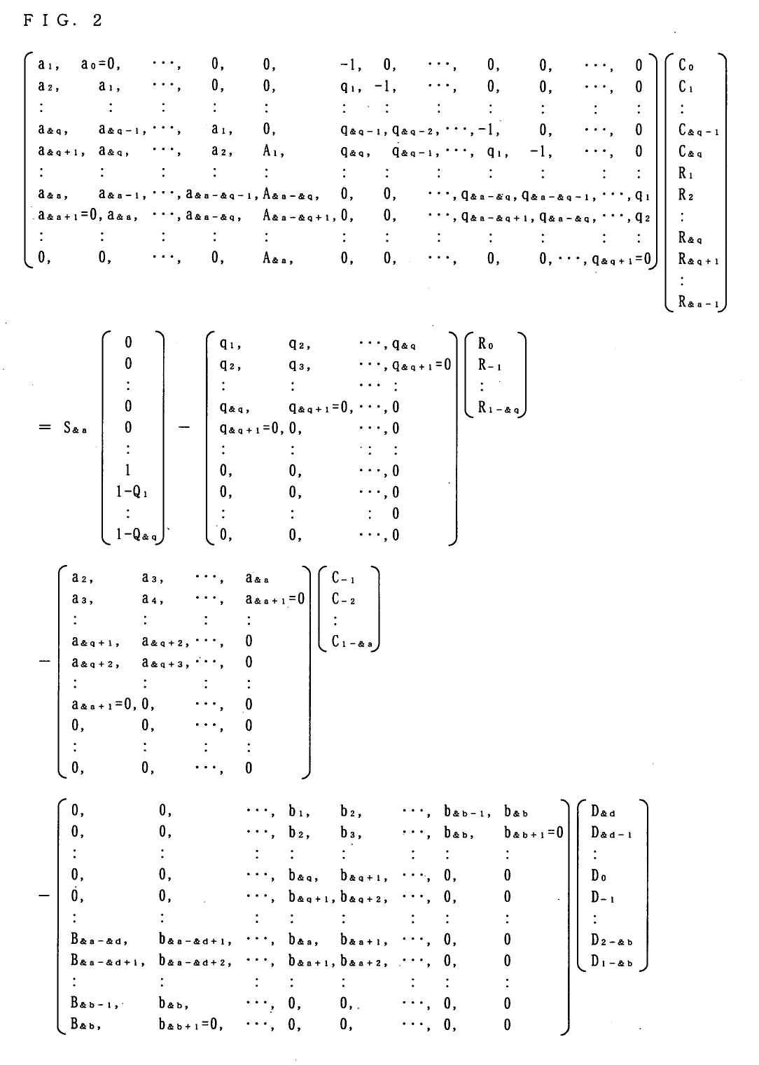

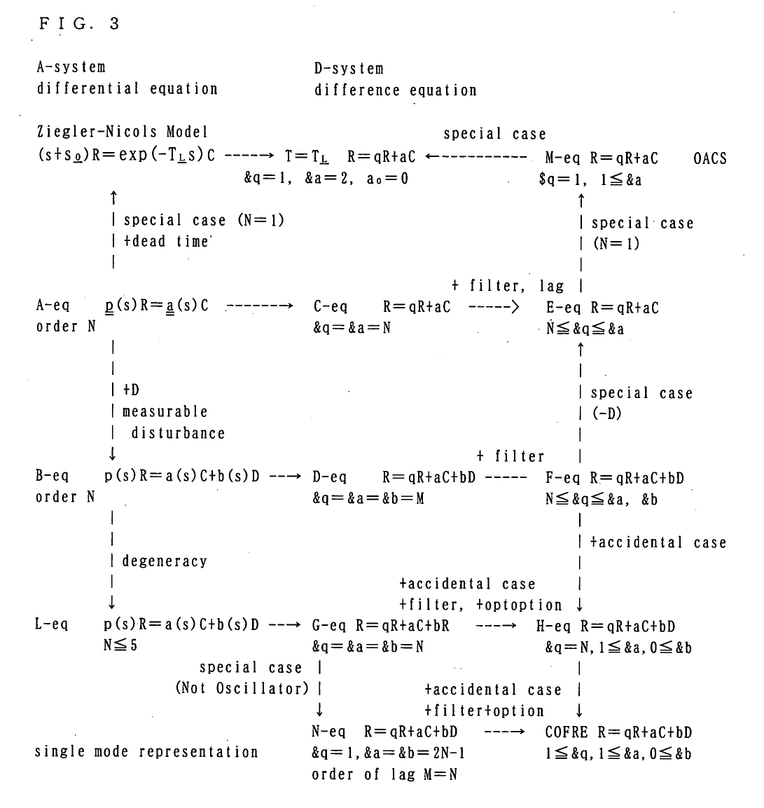

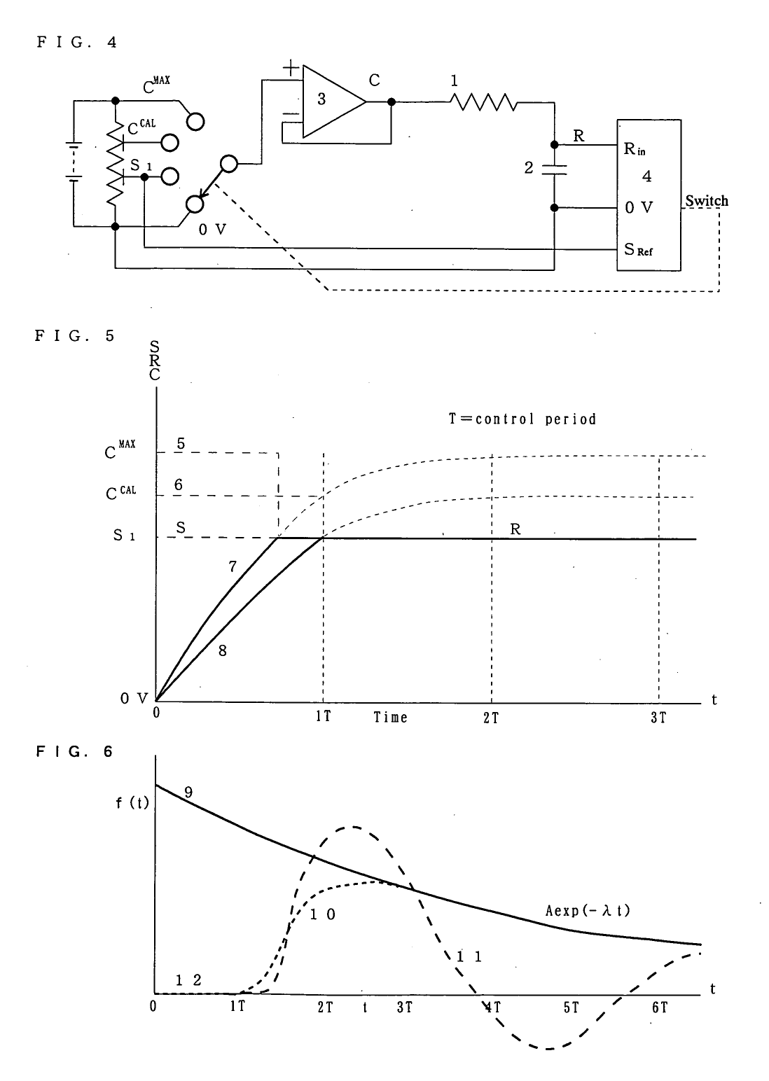

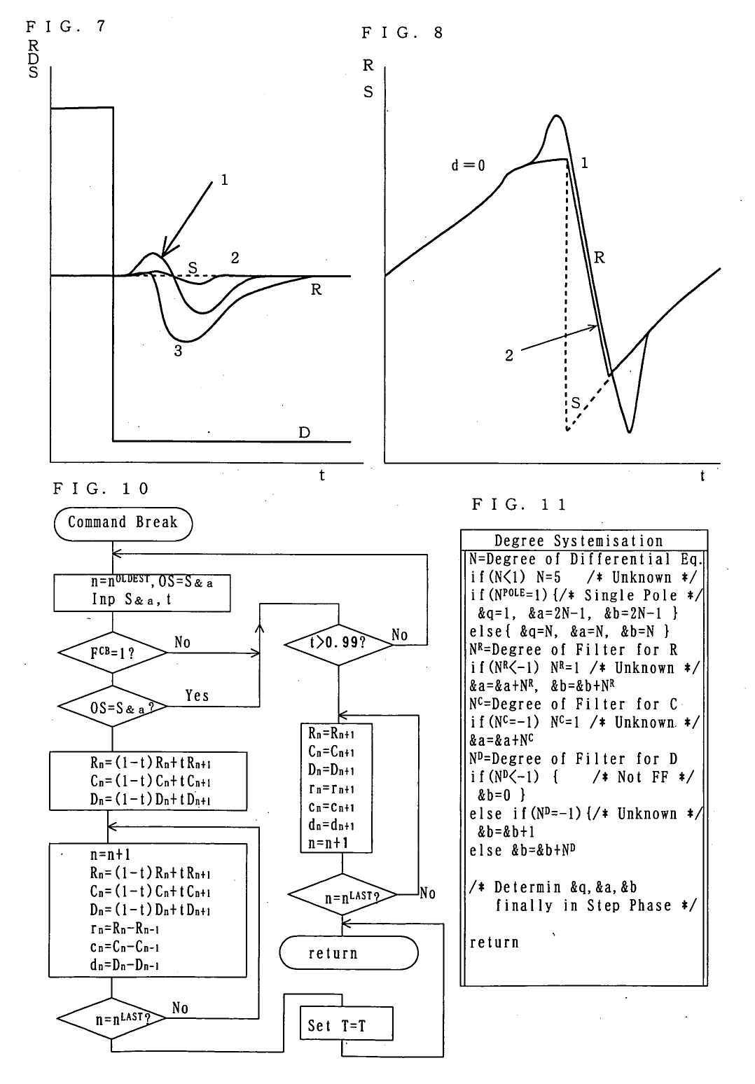

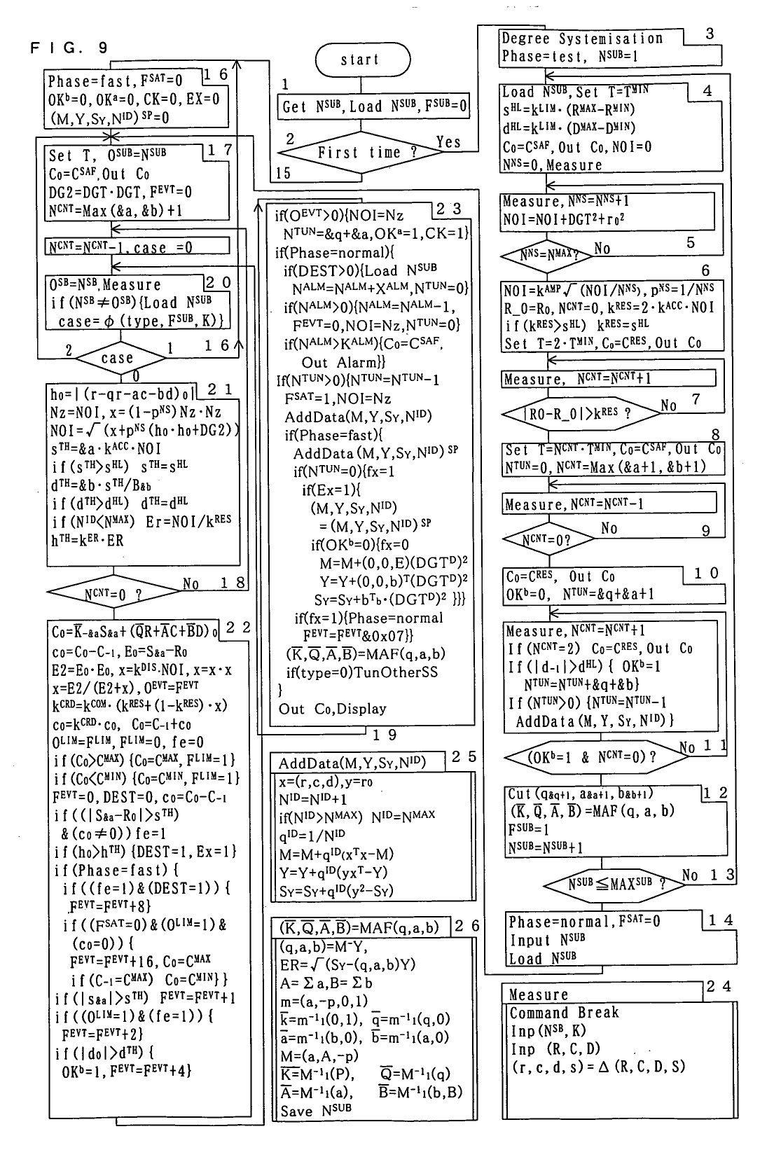

Explanation of Symbols

1. Initialisation. Get reserved data

2. If the operation is first time the system enters into test phase.

3. Temporary value of degree of COF (&q, &a and &b) is determined by ‘Degree Systemisation’ and preparation for test phase.

4. Preparation for the subsystem of No. N^{SUB}.

5. Measurement of noise level.

6. Make root mean square and preparation for determination of the control period.

7. Measurement of rising time.

8. Optimisation of the period and preparation for response test.

9. Waiting to complete control data.

10. Start of response test.

11. Response test and collecting data for tuning.

12. Omission of excess terms and identification of COF and MAF

13. Response phase loop for other subsystems.

14. Entering into normal phase.

15. Branch of restart.

16. Preparation of fast phase.

17. Preparation of normal phase and preparation for waiting to complete control data.

18. Waiting loop to complete control data.

19. Main loop of fast phase and normal phase.

20. Measurement and check the signal of subsystem exchange and manual request for fast tuning.

21. Measurement of noise level and preparation of thresholds.

22. Calculation and limitation of ‘C₀’, and judgement of events.

23. Management when destroyer event happens and output of ‘C₀’. Prohibition of tuning and enforcement of fast tuning. Fast tuning is enforced by that tuning set is exchanged with spare tuning set, which includes only new data, and is supplemented with data for ‘b’. The system changed from fast phase to normal phase when data for ‘b’ is completed.

24. Measurement subroutine. Input of ‘S’ and renovation of the control period and arrangement the degree of COV so that 0th degree represents the present period by command breaking. Check the signals for subsystem exchange ‘K’ and manual request. Measurement of COV and making differences.

25. Addition of tuning data to tuning set.

26. Calculation of COF and MAF, and saving data to nonvolatile memory.

FIG. 10 is the flow chart of the subroutine ‘Command break’. In the subroutine the command is got and when the art of command breaking is allowed (F^{CB}=1) and new command is given (0S≠S_{&a}) then COV is exchanged with the time weighted average value and new period is let start (Set T=T) in the road of the control period. When command breaking is not allowed or new command is not given the system is let wait for the end of the period (t>0.99) and COV is renewed for the new period. ‘t’ is a timer that becomes 0 at the beginning of the period and 1 at the end of the period.

FIG. 11 is the flow sheet of the subroutine ‘Degree systemisation’. The phrase between ‘/*’ and ‘*/’ is the comment. If the degree of the corresponding differential equation is unknown it is supposed ‘5’. ‘N^{POLE}=1’ means single pole representation. If single pole representation each degree of ‘&q’, ‘&a’ and ‘&b’ is momentary supposed ‘1’, ‘2N−1’ and ‘2N−1’ respectively. Else each of them is momentary supposed ‘N’. And each filter effect is added to them. The degree of unknown filter is supposed ‘1’.

### THE BEST WORKING MODE OF THE INVENTION

The invention is applicable to from the simple system to the complex system. Therefore we describe the simple mode at first. When the invention is substituted for PID system ‘&q=1, &a=2’ is sufficient in many cases. ‘C₀’ is calculated by (J01) in this mode (C22).

C₀=C₋₁+\overline{k}₀(S₁−R₀)+\overline{q}₀(R₀−R₋₁)+\overline{a}₁(C₋₁−C₋₂) (J01)

This MAFRE is very simple. However, the control period must be optimised because ‘R’ rises up less than 4 bits within several periods of many PID systems. If the system has more than 12 bits AD-converter then the period is set so that ‘R’ rises more than 8 bits within two periods in the response test that ‘C’ is set ‘C^{MAX}’. COF is identified by the following using data of the response test.

x_{nε[3]}≡(Rₙ₋₁, Cₙ₋₁, Cₙ₋₂), X≡(x₁^{T}, x₂^{T}, x₃^{T})^{T},

Y≡(R₁, R₂,R₃)^{T}, COF≡(q₁, a₁, a₂)^{T}, COF=X⁻¹Y (J02)

MAF is calculated using COF as the following (C41).

\overline{k}₀=1/(a₂+q₁a₁)=1/KT_{L},

\overline{q}₀=−q₁{a₂+q₁(a₁+a₂)}/{(a₁+a₂)(a₂+q₁a₁)},

\overline{a}₁=−a₂{a₂+q₁(a₁+a₂)}/{(a₁+a₂)(a₂+q₁a₁i)} (C41)

When COF is considered constant such as mass productions (J01) can use COF identified in the factory. This is the simplest mode. The system is stable because automatic tuning is not carried out. The settling time is two periods in this mode. Therefore, control speed is very fast.

If the system is complex and the control precision is requested then the invention must be carried out selecting necessary procedures of the invention or of the previous NACS. We describe the procedures.

1. The control period is determined by optimisation of period so that COF can be identified above the fixed precision.

2. The degree of COF is determined by degree systemisation. Namely, when the corresponding differential equation is supposed the ‘&q’, ‘&a’ and ‘&b’ are supposed ‘N’ the degree of the equation. If the equation cannot be considered the ‘&q’, ‘&a’ and ‘&b’ are supposed ‘5’. This value can be decreased or increased investigating the system. When single pole representation is preferred ‘&a’ and ‘&b’ is supposed ‘2M-1’. The degrees of effective filters are supposed next. If the supposition is difficult then the filters of degree ‘1’ are supposed. ‘&a’ is added by the degrees of the filters for ‘R’ and ‘C’ and ‘&b’ is added by the degrees of the filters for ‘R’ and ‘D’. When ‘q’, ‘a’ and ‘b’ is identified in response test negligible terms of ‘q’, ‘a’ and ‘b’ are omitted.

3. COF is identified in response test, in fast tuning and in normal tuning by the regression method that observation equation is COFRE.

4. COF is identified by tuning diagnosis in normal phase only when it is judged that COF is identified above the fixed precision and not-measurable disturbance, which are greater than noise level, doesn't happen. The estimation gap is watched and as soon as its abnormal deviation is observed automatic tuning is stopped. Thus automatic tuning can be carried out without unstability.

5. COF is identified by fast tuning when the system is restarted so that the system can adapt for the change during the interruption. The destroyer event is considered in fast phase that the system is changed and COF is wrong. The estimation gap is also watched in restart and only when its abnormal deviation is observed newly tuned data is substituted for old tuned data. Thus the system can rapidly adapt for repair and exchange of components during the interruption.

6. The manipulated variable is calculated out solving COFRE under the condition of FT-determining. Man can use its solution formula namely MAFRE. Using MAFRE, man can combine the command and select MAFRE. Exchanging parameters of NACS, various subsystems can be exchanged. When the command concerns the relation of the sum and the difference between them COF becomes common between them. If all COV of all subsystems can be observed in each subsystem then subsystems can be exchanged without waiting time to collect data for control.

7. For the shortest delay time between the command change to the settling the command can be set by command breaking. New period is started in the road of the control period exchanging COV with the time weighted average value.

8. If the system is noisy, noise compression and/or error distribution can be used in stead of filters so that the manipulated variable is amended before output.

Applicability to the Industry

Industry cannot work without control technology today. The invention offers very precise and simple control technology. It is applicable to from the simple system to the very complex system. Feed forward, it is a dream for PID, can be naturally realised. The size of parameter is theoretically and easily determined. The control period can be optimised. The system can defence against not measurable disturbance and can rapidly adapt for repair and exchange of components when automatic tuning is carried out. NACS of the invention can be applicable to the variety of systems and the following can be said.

The settling time is minimal.

The manipulated variable can be easily calculated.

Noise is reduced.

The control period is long enough.

The system is very stable.

Feed forward of the measurable disturbance is easy.

Control parameters are tuned automatically.

The system itself can be automatically constituted. Namely the control period and the degree of COF can be determined automatically.

The theoretical background is steady.

Theory and procedures are easily understood.

The invention offers a new intelligent control system. The theoretical derivation of the system of the invention is indeed complicated and difficult, but the result is very clear and simple and easily understood. Man who has a patience to understand the system of the invention can easily use the invention.

1. Digital control method where the system is represented by COFRE, the manipulated variable is calculated out solving COFRE under the condition of FT-determining and COF is identified by the regression of COFRE.

2. Digital control method of claim 1 that is characterised by that manipulated variable is calculated using MAFRE.

3. Digital control method of claim 1 that is characterised by that COF is identified by tuning diagnosis only when it is judged that COF is identified above the fixed precision and not-measurable disturbance, which are greater than noise level, doesn't happen.

4. Digital control method of claim 1 that is characterised by that COF is identified by fast tuning when the system is restarted so that the system can adapt for the change during the interruption.

5. Digital control method of claim 1 that is characterised by that the control period is determined by optimisation of period so that COF can be identified above the fixed precision.

6. Digital control method of claim 1 that is characterised by that degree of COF is determined by degree systemisation.

7. Digital control method of claim 1 that is characterised by that the command is set by command breaking.

8. Digital control method of claim 1 that is characterised by that the manipulated variable is amended by noise compression and/or error distribution before output.
